(19) United States
(12) Patent Application Publication
(10) Pub. No.: US 2016/0126680 A1
(43) Pub. Date: May 5, 2016

(54) TERMINAL UNIT, MOTOR ACTUATOR AND TERMINAL HOLDER

(71) Applicant: TGK CO., LTD., Tokyo (JP)

(72) Inventor: Koichi Maeda, Tokyo (JP)

(21) Appl. No.: 14/920,285

(22) Filed: Oct. 22, 2015

(30) Foreign Application Priority Data
Oct. 30, 2014 (JP) 2014-221850
Aug. 4, 2015 (JP) 2015-154502

(51) Int. Cl. H01R 13/66; H02K 11/00; H01R 13/40

(52) U.S. Cl. CPC H01R 13/6608; H01R 13/40; H02K 11/0094

(57) ABSTRACT

A terminal unit includes a first terminal having a first connected part, a second terminal, having a second connected part, which is arranged in a lateral direction at intervals relative to the first connected part, a first electronic component arranged between the first connected part and the second connected part, and a terminal holder that holds the first terminal and the second terminal, the terminal holder having a receiving portion for receiving the first electronic component. The first electronic component is such that a different external electrode in the pair of external electrodes is electrically connected to the first connected part and the second connected part by way of electric conductors, and the position of the first electronic component relative to the receiving portion is held by the electric conductors.

### CLAIM OF PRIORITY

This application claims priority to Japanese Patent Application No. 2015-154502, filed on Aug. 4, 2015, and also claims priority to Japanese Patent Application No. 2014-221850, filed Oct. 30, 2014, both of which are incorporated herein by reference.

### BACKGROUND OF THE INVENTION

1. Field of the Invention

The present invention relates to a terminal unit, where a plurality of terminals are unitized, a motor actuator using the terminal unit, and a terminal holder used for the terminal unit.

2. Description of the Related Art

A motor actuator (hereinafter simply referred to as “actuator” also) is conventionally used as a drive source for various mechanical devices (see Reference (1) in the following Related Art List, for instance). The actuator includes a housing, an electric motor contained in the housing, and a plurality of terminals connected to motor terminals of the electric motor.

### RELATED ART LIST

(1) Japanese Unexamined Patent Application Publication No. Hei08-154358.

In this type of actuators, there are cases where noise occurs in the power supply line, through which the electric power is supplied to the electric motor, due to an electrostatic surge, lightning surge and so forth. In other countries like Europe, EMC (Electromagnetic Compatibility) countermeasures are required to be taken for the purpose of preventing malfunctions from occurring in the electric motor in the event that such noise occurs. As the EMC countermeasures, for example, an electronic component for the countermeasures against noise (hereinafter referred to as “noise countermeasure component” also), such as a capacitor, is connected between a pair of power supply lines.

FIG. 31 shows an exemplary noise countermeasure structure according to the conventional practice.

A noise countermeasure component 210 is placed on a first conductive pattern 214 and a second conductive pattern 216 of a circuit board 212 and is bonded thereto by using solders. One ends of a first motor-side terminal 218 and a second motor-side terminal 220, respectively, are connected to the circuit board 212, and the other ends thereof are connected to motor terminals 224 of an electric motor 222. Also, one ends of a first power-supply-side terminal 226 and a second power-supply-side terminal 228, respectively, are connected to the circuit board 212, and the other ends thereof are electrically connected to an external power supply apparatus. Each of the terminals 218, 220, 226 and 228 is inserted into a through-hole of the circuit board 212 and is bonded by solder. The first motor-side terminal 218 and the first power-supply-side terminal 226 electrically conduct with each other through the first conductive pattern 214, thereby constituting a first power supply line. The second motor-side terminal 220 and the second power-supply-side terminal 228 electrically conduct with each other through the second conductive pattern 216, thereby constituting a second power supply line.

In a conventional noise countermeasure structure, the number of solder joints 230 for each component soldered to the circuit board 212 is a total of six spots, which is considered many. Normally, solder contains flux that is an insulating material. The flux may possibly be scattered around if solder is evaporated in a process where it is heated. When flux adheres to a conductive path such as the terminals and/or electrodes of the terminals 218 and 220 or the like, this may cause faulty conduction. For this reason, it is desired that the number of solder bonding spots (namely, the number of solder joints) be reduced as much as possible.

### SUMMARY OF THE INVENTION

The present embodiment has been made to solve such problems, and one of purposes thereof is to provide a terminal unit having a structure suitable for the reduction of the number of solder joints when electronic components are electrically connected to a plurality of terminals.

In order to resolve the aforementioned problems, a terminal unit according to one embodiment of the present invention includes: a first terminal having a first connected part; a second terminal, having a second connected part, which is arranged in a lateral direction at intervals relative to the first connected part; a first electronic component where a pair of external electrodes are provided in an outer surface, the first electronic component being arranged between the first connected part and the second connected part; and a terminal holder that holds the first terminal and the second terminal, the terminal holder having a receiving portion for receiving the first electronic component, wherein the first electronic component is such that a different external electrode in the pair of different external electrodes are electrically connected to the first connected part and the second connected part by way of an electric conductor and wherein a position of the first electronic component relative to the receiving portion is held by the electric conductor.

### BRIEF DESCRIPTION OF THE DRAWINGS

Embodiments will now be described by way of examples only, with reference to the accompanying drawings which are meant to be exemplary, not limiting, and wherein like elements are numbered alike in several Figures in which:

FIG. 1 is a perspective view showing an internal structure of an actuator where a terminal unit according to a first embodiment is used;

FIG. 2 is a plan view showing a state where a terminal unit, according to a first embodiment, and an electric motor are combined together;

FIG. 3 is a perspective view of a terminal unit according to a first embodiment;

FIG. 4A is a plan view of a terminal unit according to a first embodiment;

FIG. 4B is a plan view of a terminal holder used for a terminal unit;

FIG. 5A is a cross-sectional view taken along the line A-A of FIG. 4A;

FIG. 5B shows a state where the noise countermeasure component is placed on the receiving portion;

FIG. 6 is a cross-sectional view taken along the line B-B of FIG. 4A;

FIG. 7 is a cross-sectional view taken along the line C-C of FIG. 4B;

FIG. 8 is a bottom view of a terminal unit according to a first embodiment;

FIG. 9 is a plan view of a terminal unit according to a second embodiment;

FIG. 10 is a cross-sectional view taken along the line D-D of FIG. 9;

FIG. 11 is a plan view of a terminal unit according to a third embodiment;

FIG. 12 is an exploded perspective view of a terminal unit according to a third embodiment;

FIG. 13 is a perspective view of a terminal holder according to a third embodiment;

FIG. 14 is a cross-sectional view taken along the line A-A of FIG. 11;

FIG. 15 is a perspective view of an enlarged part of a terminal unit according to a third embodiment;

FIG. 16 is a cross-sectional view taken along the line B-B of FIG. 11;

FIG. 17 is a cross-sectional view taken along the line C-C of FIG. 11;

FIG. 18 is a cross-sectional view of an entire terminal unit as viewed from the same viewpoint as FIG. 16;

FIG. 19 shows an in-process state of assembling a first terminal and a second terminal in a terminal unit according to a third embodiment;

FIG. 20 shows an in-process state of assembling a left conductive member and a right conductive member in a terminal unit according to a third embodiment;

FIG. 21 shows an in-process state of assembling a noise countermeasure component in a terminal unit according to a third embodiment;

FIG. 22A shows a shape of a conductive member according to a reference example;

FIG. 22B shows an in-process state of assembling a noise countermeasure component to a conductive member according to a reference example;

FIG. 22C shows a shape of a conductive member according to a third embodiment;

FIG. 22D shows an in-process state of assembling a noise countermeasure component to a conductive member according to a third embodiment;

FIG. 23 is a perspective view of a motor actuator according to a third embodiment;

FIG. 24 is an exploded perspective view of a motor actuator according to a third embodiment;

FIG. 25 is a cross-sectional view of a terminal unit according to a first modification;

FIG. 26A is a plan view of a terminal unit according to a second modification;

FIG. 26B is a cross-sectional view taken along the line E-E of FIG. 26A;

FIG. 27A is a cross-sectional view of a terminal unit according to a third modification;

FIG. 27B is a cross-sectional view of a terminal unit according to a fourth modification;

FIG. 28 is a plan view of an enlarged part of a terminal unit according to a fifth modification;

FIG. 29 is a cross-sectional view taken along the line D-D of FIG. 28;

FIG. 30 is a cross-sectional view taken along the line E-E of FIG. 28; and

FIG. 31 shows an exemplary noise countermeasure structure according to the conventional technology.

### DETAILED DESCRIPTION OF THE INVENTION

In the following description of each embodiment, the identical components are given the identical reference numerals and the repeated description thereof will be omitted as appropriate. Also, some components are omitted as appropriate in each Figure.

### First Embodiment

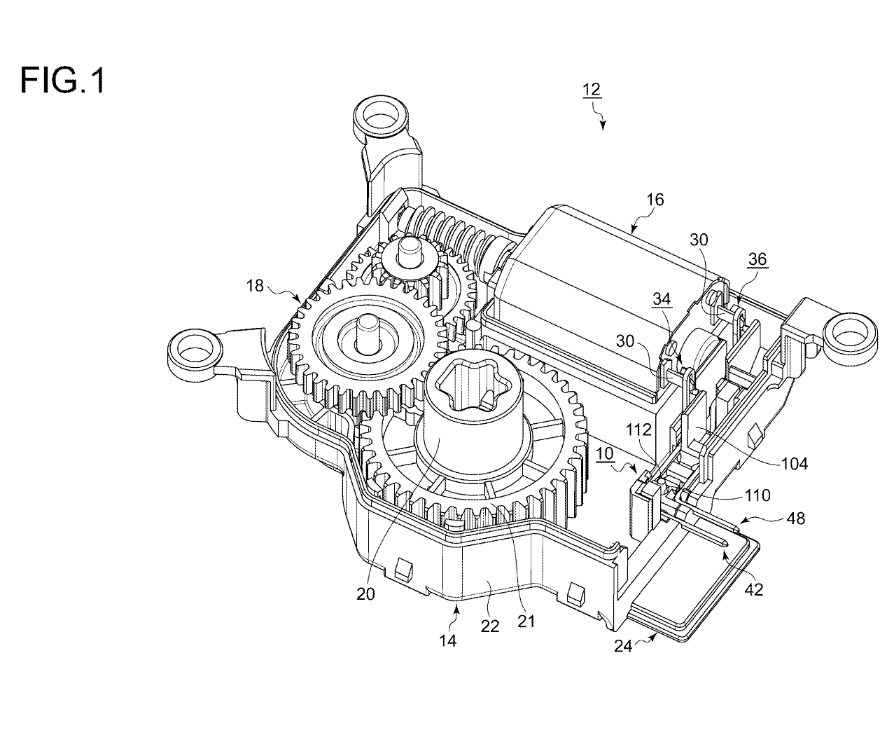

FIG. 1 is a perspective view showing an internal structure of an actuator 12 where a terminal unit 10 according to a first embodiment is used.

The actuator 12 includes a housing 14, an electric motor 16 contained in the housing 14, a speed reducing mechanism 18 (e.g., reduction gears) that reduces the rotational speed of a not-shown motor shaft of the electric motor 16 and transmits the rotation thereof, and an output shaft 20 that outputs the rotation thereof transmitted by the speed reducing mechanism 18. The housing 14 is comprised of a first casing (not shown) and a second casing 22, which are of a shape such that the housing 14 is divided in an axial direction of the output shaft 20. A connector part 24 is provided on a lateral portion of the housing 14, and an external connector (not shown) is attached to the connector part 24.

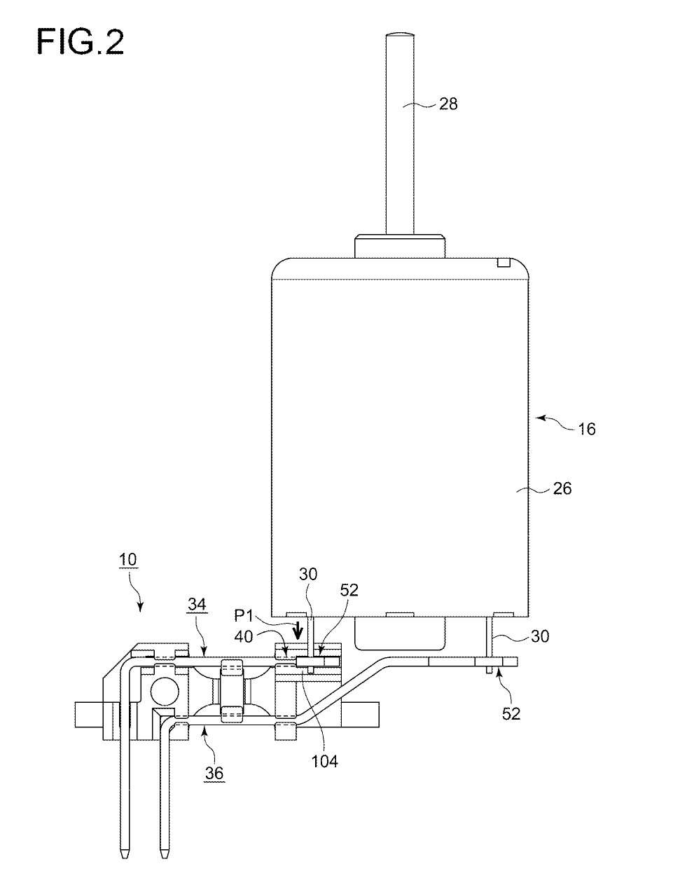

FIG. 2 is a plan view showing a state where the terminal unit 10 and the electric motor 16 are combined together.

The electric motor 16 is a DC (direct-current) motor and has a motor casing 26, a rotational shaft 28 that protrudes from the motor casing 26, and a plurality of motor terminals 30 that protrude from the motor casing 26 and are directed to the opposite side of the protruding direction of the rotational shaft 28. Each motor terminal 30 functions as a power supply terminal for supplying the electricity to internal components such as a coil of the electric motor 16.

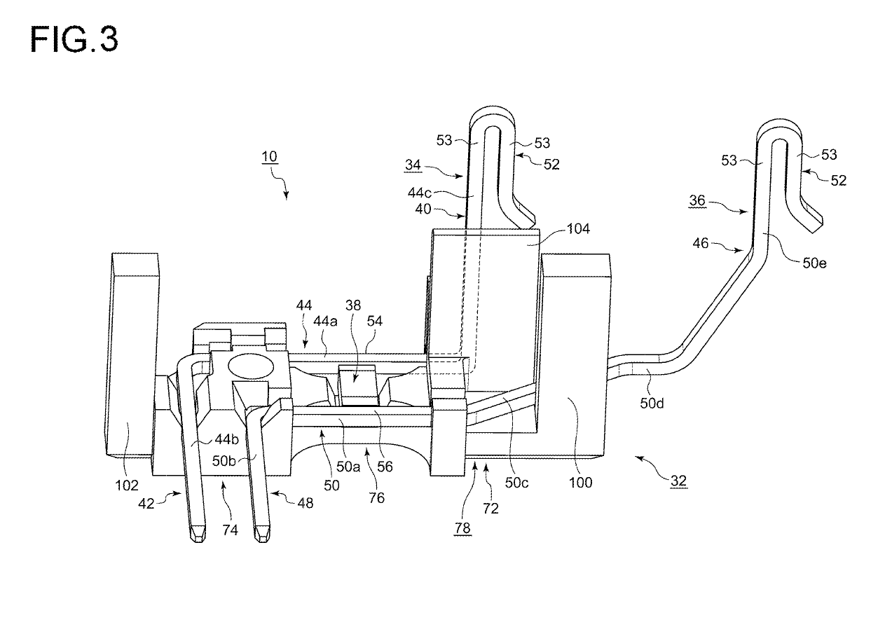

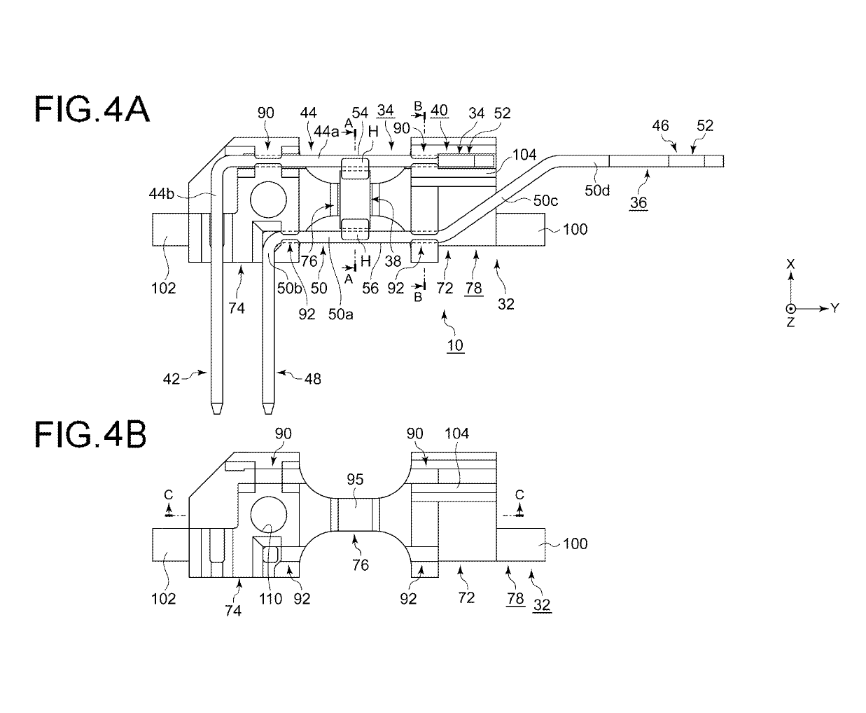

FIG. 3 is a perspective view of the terminal unit 10. FIG. 4A is a plan view of the terminal unit 10, and FIG. 4B is a plan view of a terminal holder 32 used for the terminal unit 10 (hereinafter, the terminal holder 32 will be simply referred to as a “holder 32” also). Solders H described later are omitted in FIG. 3.

A description is given hereinbelow of the positional relationship of each component using a lateral direction X, a front-back direction Y and a height direction Z of the holder 32. Each direction is defined based on a case where the holder 32 is placed on a horizontal plane such that a receiving surface 95 of a receiving portion 76 of the holder 32 (the receiving surface 95 and the receiving portion 76 will be discussed later; see FIG. 4B) is located toward an upper side in the vertical direction. The lateral direction X of the holder 32 is a horizontal direction where a left connected part 54 of a first terminal 34 and a right connected part 56 of a second terminal 36 are arranged. Also, the front-back direction Y of the holder 32 is a horizontal direction perpendicular to the lateral direction X, whereas the height direction Z is a vertical direction. “Right” and “left” indicate one side of the lateral direction X of the holder 32 and the other side thereof, respectively. “Front” and “back (rear)” indicate one side of the front-back direction Y of the holder 32 and the other side thereof, respectively. “Up (upward)” and “down (downward)” indicate one side of the height direction Z of the holder 32 and the other side thereof, respectively.

In addition to the holder 32, the terminal unit 10 includes a first terminal 34, a second terminal 36, and an electronic component 38 for the countermeasures against noise (hereinafter referred to as “noise countermeasure component 38” also).

The first terminal 34 and the second terminal 36 connect the electric motor 16, which serves as a first electric apparatus, and an external power supply apparatus, which serves as a second electric apparatus. The first terminal 34 constitutes a part of a first power supply line, and the second terminal 36 constitutes a part of a second power supply line. A power supply voltage is supplied to each power supply line by way of a motor driver of the external power supply apparatus in such a manner that one power supply line functions as a ground potential while the power supply voltage is supplied to the other power supply line.

The noise countermeasure component 38 is electrically connected to the electric motor 16 in parallel therewith in between the first terminal 34, which serves as the first power supply line, and the second terminal 36, which serves as the second power supply line. The noise countermeasure component 38 is a capacitor, and functions as a noise filter for suppressing the noise occurring in each power supply line.

Each of the terminals 34 and 36 is a molded component obtained when a wire rod, such as copper or gold, having an electric conductivity is subjected to a forming processing, for instance. The cross-section of each of the terminals 34 and 36 is formed in an N-cornered polygon shape, such as a triangle, a square, a rectangle or the like (N being an integer greater than or equal to 3), for instance; however, the cross-sectional shape thereof is not limited thereto. Each of the terminals 34 and 36 is so provided as to correspond to each of the motor terminals 30 of the electric motor 16.

The first terminal 34 has a motor connector 52 provided on one end side, a first external connector 42 provided on the other end side, and a first intermediate portion 44 provided between the motor connector 52 and the first external connector 42.

The first intermediate portion 44 has a first part 44a that extends in the front-back direction Y, a second part 44b that extends rightward from a rear end of the first part 44a, and a third part 44c that extends upward from a front end of the first part 44a. The first external connector 42 is provided at a lateral end of the second part 44b. The motor connector 52 is provided at an upper end of the third part 44c. The third part 44c is a first upright part 40 that stands upward from one end side of the first terminal 34.

The second terminal 36 has a motor connector 52 provided on one end side of the second terminal 36, a second external connector 48 provided on the other end side thereof, and a second intermediate portion 50 provided between the motor connector 52 and the second external connector 48.

The second intermediate portion 50 has a first part 50a that extends in the front-back direction Y, and a second part 50b that extends rightward from a rear end of the first part 50a. The second external connector 48 is provided at a lateral end of the second part 50b. Also, the second intermediate portion 50 has a third part 50c that extends obliquely frontward from a front end of the first part 50a, a fourth part 50d that extends from a front end of the third part 50c in the front-back direction Y, and a fifth part 50e that extends upward from a front end of the fourth part 50d. The motor connector 52 is provided at an upper end of the fifth part 50e. The fifth part 50e is a second upright part 46 that stands upward from one end side of the second terminal 36.

The motor connector 52 is formed by folding back a part of the wire rod, and the motor terminal 30 is placed between a pair of opposing parts 53 whose inner side surfaces face each other. The motor connector 52 of each of the terminals 34 and 36 is bonded to the corresponding motor terminal 30 by using a solder or the like, and is thereby electrically connected to the electric motor 16 (see FIG. 2 as well). The external connectors 42 and 48 of the terminals 34 and 36, respectively, are arranged within the connector part 24, and are electrically connected to the external power supply apparatus by way of not-shown external connection terminals (see FIG. 1 as well).

The left connected part 54 (first connected part) is provided at an intermediate position of the first intermediate portion 44 of the first terminal 34, and the right connected part 56 (second connected part) is provided at an intermediate position of the second intermediate portion 50 of the second terminal 36. The left connected part 54 and the right connected part 56 are electrically connected to each other by way of the noise countermeasure component 38. The right connected part 56 is arranged in the lateral direction X at intervals relative to the left connected part 54. More specially, the left connected part 54 and the right connected part 56 are arranged in parallel with each other with a spacing being formed therebetween (see FIG. 4A).

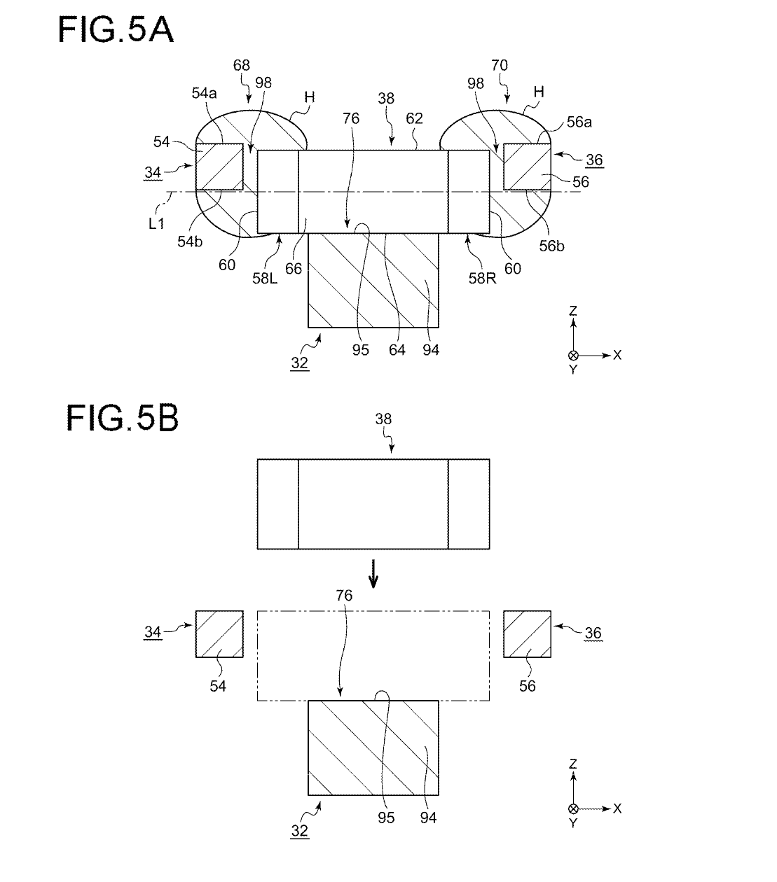

FIG. 5A is a cross-sectional view taken along the line A-A of FIG. 4A. FIG. 5B shows a state where the noise countermeasure component 38 is placed on the receiving portion 76 (described later).

The noise countermeasure component 38 is arranged between the left connected part 54 of the first terminal 34 and the right connected part 56 of the second terminal 36. The noise countermeasure component 38 is a so-called surface-mounted electronic component where there is no lead component for electrically connecting to an external wiring. The noise countermeasure component 38 is formed in a rectangular parallelepiped shape; a pair of external electrodes 58 are provided on outer surfaces of sides thereof located opposite to the terminals 34 and 36, respectively, in the lateral direction X. The pair of external electrodes 58 include a left external electrode 58L (one of the pair thereof) and a right external electrode 58R (the other of the pair of thereof). The external electrodes 58 are formed on (i) a lateral surface 60 of the noise countermeasure component 38 facing the connected part 54 (56) of the terminal 34 (36), (ii) a part of an upper-side surface 62, a lower-side surface 64, a front-side surface (not shown) and a rear-side surface 66 which are continuing into the lateral surface 60.

The left connected part 54 of the first terminal 34 and the left external electrode 58L of the noise countermeasure component 38 are bonded together by a solder H, and a first bonding part 68 is provided therebetween. The right connected part 56 of the second terminal 36 and the right external electrode 58R of the noise countermeasure component 38 are bonded together by a solder H, and a second bonding part 70 is provided therebetween. Mutually different external electrodes 58 in the pair of external electrodes 58 are bonded respectively to the left connected part 54 and the right connected part 56 via the solders H, which are electric conductors; as a result, the noise countermeasure component 38 is electrically connected to the left connected part 54 and the right connected part 56. A position of the noise countermeasure component 38 relative to the receiving portion 76 (described later) of the holder 32 is held by the solder H.

As shown in FIG. 4B, the holder 32 includes a holder body 78. This holder body 78 has a first base 72 provided at a front side, a second base 74 provided at a rear side, and a receiving portion 76 provided between the first base 72 and the second base 74. The holder 32, which is made of a material such as resin, is a molded component obtained such that the constituting parts of the holder 32 are integrally formed with each other. The first base 72 is formed in a flat plate shape. The second base 74 is formed in a flat plate shape.

The holder 32 includes a plurality of first holding portions 90 for holding the first intermediate portion 44 of the first terminal 34, and a plurality of second holding portions 92 for holding the second intermediate portion 50 of the second terminal 36. One of the first holding portions 90 is formed on a left side of the first base 72, and another one of the first holding portions 90 is also formed in the second base 74. One of the second holding portions 92 is formed on a right side of the first base 72, and another one of the second holding portions 92 is also formed in the second base 74.

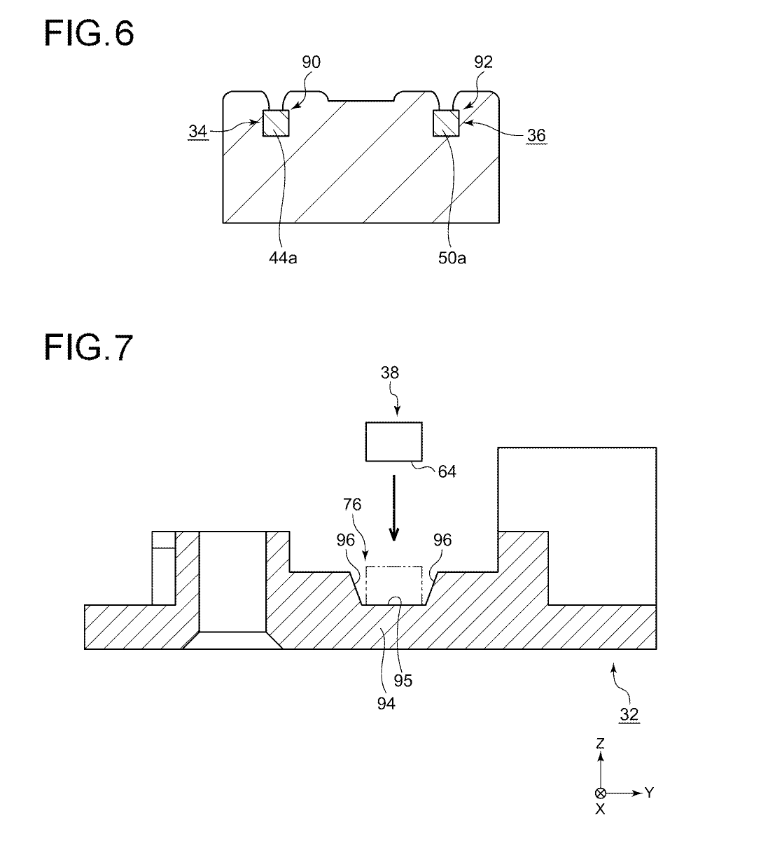

FIG. 6 is a cross-sectional view taken along the line B-B of FIG. 4A. The intermediate portions 44 and 50 of the terminals 34 and 36, respectively, are inserted into the holding portions 90 and 92, respectively. Each of the holding portions 90 and 92 is formed such that a part of the holder 32 is swaged.

FIG. 7 is a cross-sectional view taken along the line C-C of FIG. 4B. The receiving portion 76 of the holder 32 is open upward and is formed into a groove shape that extends in the lateral direction X. The receiving portion 76 has a bottom wall 94 where a receiving surface 95 is provided, and a pair of side walls 96 that upstand from both front and rear ends of the receiving surface 95. As shown in FIG. 5B, the noise countermeasure component 38 is received and supported by the receiving portion 76 from below while the noise countermeasure component 38 is in surface contact with the receiving surface 95 of the receiving portion 76.

When the noise countermeasure component 38 is placed on the receiving portion 76, it is engaged with the lateral surfaces of the left connected part 54 and the right connected part 56. Thereby, the noise countermeasure component 38 is positioned relative to the receiving portion 76 in the lateral direction X. Also, as shown in FIG. 7, when the noise countermeasure component 38 is placed on the receiving portion 76, the receiving portion 76 is engaged with the side walls 96. Thereby, the noise countermeasure component 38 is positioned relative to the receiving portion 76 in the front-back direction Y. Since the pair of side walls 96 are tiled such that the groove width thereof is gradually broadened toward an upper side, the noise countermeasure component 38 is easily inserted and put from above between the side walls 96. Also, when the noise countermeasure component 38 is put and placed inside between the side walls 96, the inclinations of the side walls 86 can guide the noise countermeasure component 38, so that the noise countermeasure component 38 can be positioned in the front-back direction Y. Thus, the positioning accuracy of the noise countermeasure component 38 can be improved.

A description is given of a method for assembling the above-described terminal unit 10. The holder 32 is first placed on top of a work table or the like such that the receiving surface 95 of the holder 32 is located toward the upper side in the vertical direction. Then, the intermediate portions 44 and 50 of the terminals 34 and 36, respectively, are placed inside grooves that form the basis of the holding portions 90 and 92 of the holder 32. After this, part of the periphery of the grooves of the terminals 34 and 36 are swaged; thereby, the first holding portions 90 and 92 are formed, and the terminals 34 and 36 are held by the holding portions 90 and 92, respectively.

Then, the noise countermeasure component 38 is inserted between the left connected part 54 of the first terminal 34 and the right connected part 56 of the second terminal 36, and the noise countermeasure component 38 is placed on the receiving portion 76. At this time, the noise countermeasure component 38 is engaged with the left connected part 54 and the right connected part 56. Thereby, the noise countermeasure component 38 is positioned relative to the receiving portion 76 in the lateral direction X. Also, the noise countermeasure component 38 is engaged with the side walls 96 of the receiving portion 76. Thereby, the noise countermeasure component 38 is positioned relative to the receiving portion 76 in the front-back direction Y. As a result, the position of the noise countermeasure component 38 relative to the left connected part 54 of the first terminal 34 and the right connected part 56 of the second terminal 36 in the lateral direction X and the front-back direction Y is determined.

Then, the left connected part 54 of the first terminal 34 and the right connected part 56 of the second terminal 36 are bonded to the noise countermeasure component 38 by the solder H. Thus, the first terminal 34, the second terminal 36 and the noise countermeasure component 38 are integrally formed with each other.

By employing the above-described terminal unit 10, the circuit board 212 used in the conventional practice shown in FIG. 31 is eliminated if the first terminal 34 and the second terminal 36 are to be electrically connected to the noise countermeasure component 38. Hence, the number of components used for the terminals 218, 226, 220 and 228 constituting a pair of power supply lines is suppressed and, at the same time, the solder joints for the terminals 218, 226, 220 and 228 soldered to the circuit board 212 are no longer required. Comparing with the example of FIG. 31, a total of two components in one sides of the first motor-side terminal 218 and the first power-supply-side terminal 226 as well as one sides of the second motor-side terminal 220 and the second power-supply-side terminal 228 are reduced, and the solder joints 230, the total number of which is four, are no longer necessary. Thus, the present embodiment provides the terminal unit 10 having a configuration suitable for the reduction of the number of solder joints, when the first terminal 34 and the second terminal 36 are electrically bonded to the noise countermeasure component 38.

Also, the holder 32 has the receiving portion 76 for receiving and supporting the noise countermeasure component 38 arranged between the left connected part 54 of the first terminal 34 and the right connected part 56 of the second terminal 36. Thus, when the noise countermeasure component 38 is placed on the receiving portion 76 to assemble the terminal unit 10, simply inserting the noise countermeasure component 38 between the left connected part 54 and the right connected part 56 enables the noise countermeasure component 38 to be properly positioned through the engagement with the left connected part 54 and the right connected part 56. This improves the workability during an assembly work.

Also, when the first terminal 34 and the second terminal 36 are to be electrically connected to the noise countermeasure component 38, conceivable is a method where a pressed part having a fixing portion used to secure the noise countermeasure component 38 is used for the terminal. Generally, the terminal used as a pressed part is high-priced; besides, in such the terminal, the positioning of the noise countermeasure component 38 is not taken into consideration. In this respect, the terminal unit 10 according to the present embodiment is advantageous in that the terminal, which is a pressed part, is no longer required and the position of the noise countermeasure component 38 is easily determined.

Also, when the first terminal 34 and the second terminal 36 are to be electrically connected to the noise countermeasure component 38, conceivable is a method where the fixing portion used to secure the noise countermeasure component 38 is provided in the housing 14. When, however, the fixing portion is provided in the housing 14, a set of the first terminal 34 and the second terminal 36 needs to be assembled, separately from the noise countermeasure component 38, inside the housing 14. In this respect, by employing the terminal unit 10 according to the present embodiment, the first terminal 34, the second terminal 36 and the noise countermeasure component 38 are unitized before the terminal unit 10 is assembled inside the housing 14. This not only facilitates the delivery of the actuator 12 on a production line but also improves the workability during an assembly work where the terminal unit 10 is assembled inside the housing 14.

A description is now given of other features of the terminal unit 10.

As shown in FIG. 5A, top faces 54a and 56a of the left connected part 54 of the first terminal 34 and the right connected part 56 of the second terminal 36, respectively, are located above a center position L1 of the noise countermeasure component 38 in the height direction Z. This allows each of the lateral surfaces 60 of the noise countermeasure component 38 to be engaged with each of the terminals 34 and 36 in a position above the center position L1, when the noise countermeasure component 38 is arranged between the left connected part 54 and the right connected part 56. As a result, the noise countermeasure component 38 is less likely to slip out from between the terminals 34 and 36. Hence, the stability in the positioning of the noise countermeasure component 38 is improved.

Also, both the left connected part 54 and the right connected part 56 are arranged relative to the lateral surfaces 60 of the noise countermeasure component 38 in the lateral direction X with intervals 98 between the lateral surfaces 60 thereof and the connected parts 54 and 56. This configuration and arrangement allow a molten solder to flow into the spacing between the noise countermeasure component 38 and each of the connected parts 54 and 56, when the noise countermeasure component 38 is to be bonded by the solder H. Hence, the contact area of the noise countermeasure component 38 (and the like) and the solder H is enlarged, and the connection strength by the solder H is more likely to be ensured.

Also, undersurfaces 54b and 56b of the left connected part 54 and the right connected part 56, respectively, are located above the lower-side surface 64 of the noise countermeasure component 38. This makes it easy for the molten solder to wet-spread such that the molten solder come in contact with undersurfaces 54a and 54b of the left connected part 54 and the right connected part 56, and the lateral surfaces 60 of the noise countermeasure component 38, when the noise countermeasure component 38 is to be bonded by the solder H. Hence, the contact area of the noise countermeasure component 38 (and the like) and the solder H is enlarged, and the connection strength by the solder H is more likely to be ensured.

As shown in FIG. 3 and FIG. 4B, the holder 32 has a first gripper portion 100 that protrudes upward from a right front side of the first base 72 of the holder body 78, and a second gripper portion 102 that protrudes upward from a right rear side of the second base 74 of the holder body 78. Each of the gripper portions 100 and 102 is provided so that an operator and a robot arm can grasp the gripper portion 100 (102) when handling the terminal unit 10 including the holder 32. Each of the gripper portions 100 and 102 protrudes upward from the holder body 78 including the first holding portions 90 and the second holding portions 92. Thus, when the gripper portion is grasped, the interference to the first intermediate portion 44 (and the like) of the first terminal 34 held by the holding portions 90 and 92 (see FIG. 4B) is more likely to be suppressed.

The upright parts 40 and 46 of the terminals 34 and 36, respectively, are provided in frontward positions relative to the receiving portion 76; in contrast, the second gripper portion 102 is provided in a rearward position relative thereto. The second gripper portion 102 is located in a position away from each of the upright parts 40 and 46. Thus, when the second gripper portion 102 is grasped, the interference to the upright parts 40 and 46 of the terminals 34 and 36 is more likely to be suppressed.

The holder 32 further includes a wall-shaped posture keeping portion 104 that protrudes from a left side of the first base 72. The posture keeping portion 104 is arranged in the lateral direction X with respect to the first upright part 40 of the first terminal 34. When the first upright part 40 is to be displaced in a protruding direction P1 (see FIG. 2), the posture keeping portion 104 maintains the posture of the first upright part 40 through the engagement with the first upright part 40. This configuration and arrangement enable the position of the motor connector 52 relative to the motor terminal 30 to be easily held, when the motor connector 52 of the first upright part 40 and the motor terminal 30 are bonded together using the solder or the like. As a result, the workability during a bonding work improves.

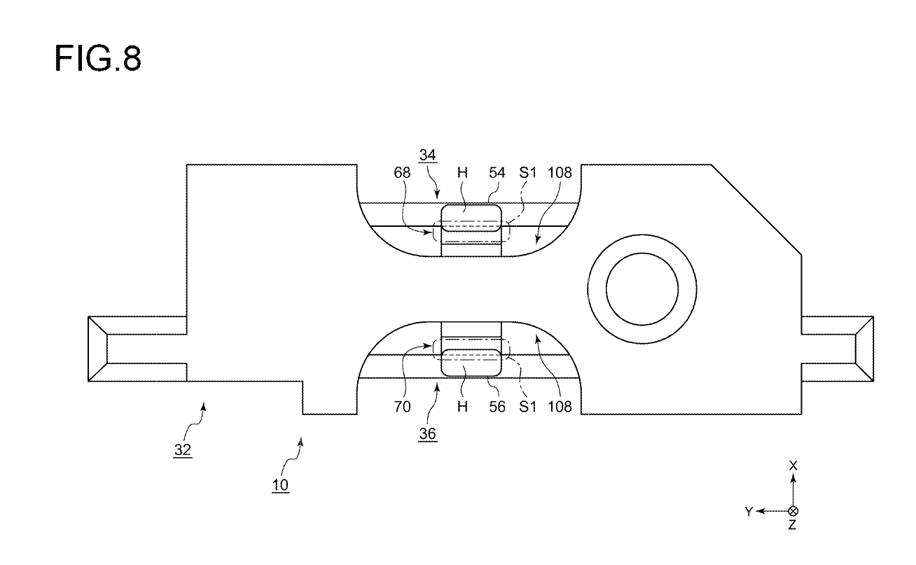

FIG. 8 is a bottom view of the terminal unit 10. As for the terminals 34 and 36, FIG. 8 shows only structures surrounding the left connected part 54 and the right connected part 56.

The holder 32 includes clearance parts 108 that are formed in such a manner as to keep away from lower-side regions S1 in relation to both the first bonding part 68 and the second bonding part 70. The clearance parts 108 are provided on both sides of the receiving portion 76 of the holder 32 in the lateral direction X. The clearance part 108 is formed such that the clearance part 108 is dented or recessed inside along the lateral direction X within a range of the front-back direction Y including the lower-side region S1 in planar view. With this configuration and arrangement, even though a molten solder drips onto the lower-side region S1 while the noise countermeasure component 38 is bonded by the solder H, the molten solder is more likely to drip onto a region surrounded by the clearance part 108. Thus, the adhesion of the molten solder to the holder 32 can be suppressed and the melting of the holder 32 can be prevented.

As described earlier, FIG. 5A is a cross-sectional view taken along the line A-A of FIG. 4A. FIG. 5A shows a cross-sectional surface obtained when the terminal unit 10 is cut along the lateral direction X and the height direction Z such that the cross-sectional surface passes through the left connected part 54 and the right connected part 56.

In this cross-sectional surface, the holder 32 is of a cross-sectional shape that is located inside the lateral direction X relative to the first bonding part 68 and the second bonding part 70. In this cross-sectional surface, the holder 32 is of a cross-sectional shape where a part thereof does not exist outside the lateral direction X relative to the first bonding part 68 and the second bonding part 70. Thus, the thermal effect is easily suppressed and the melting of the holder 32 by the heat otherwise radiated from the solder can be prevented. Here, the thermal effect as mentioned just above indicates an effect of heat caused by the heat radiation of the solder after the noise countermeasure component 38 has been bonded by the solder H.

As shown in FIG. 4B, a positioning hole 110, which runs through along the height direction Z, is formed in the second base 74. As shown in FIG. 1, a positioning pin 112, which protrudes from an inner bottom of the second casing 22, is inserted into the positioning hole 110, and the holder 32 is positioned relative to the housing 14 in front-back and side-to-side (horizontal) directions.

### Second Embodiment

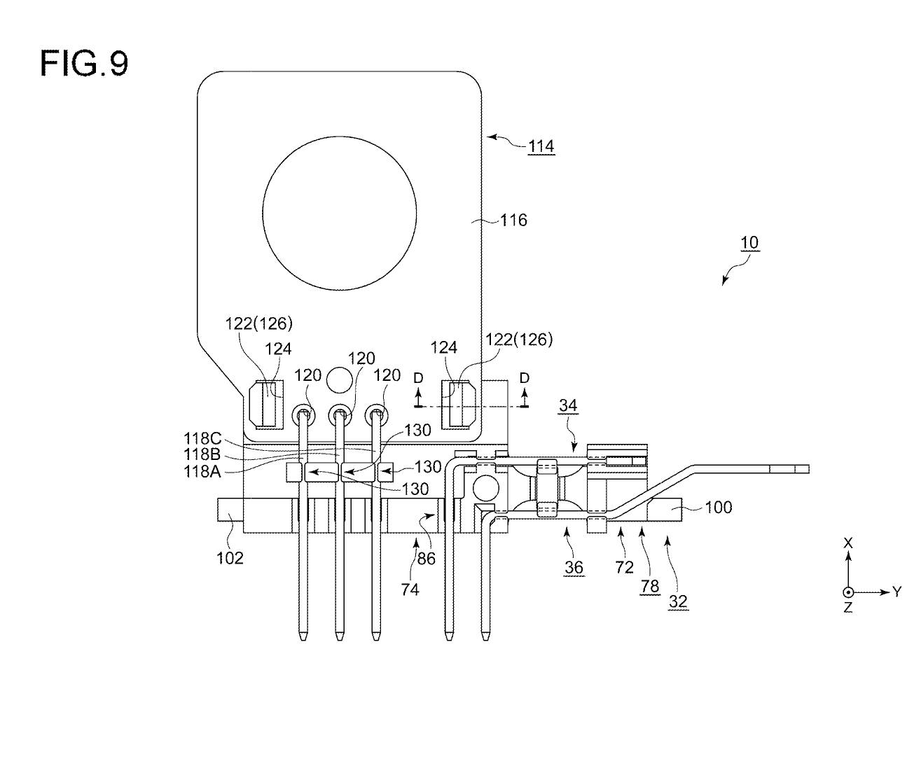

FIG. 9 is a plan view of a terminal unit 10 according to a second embodiment. The terminal unit 10 further includes a rotation sensor 114 that is used as a second electronic component used in association with the electric motor 16. The rotation sensor 114 is used to detect the rotational position of the output shaft 20 (see FIG. 1). The rotation sensor 114 has a sensor substrate 116, where a rotation detection pattern (not shown) is formed on a main surface, and a plurality of sensor terminals 118A to 118C that electrically conduct to the rotation detection pattern. The rotation detection pattern is an electrically conductive pattern and constitutes a potentiometer in combination with a brush (not shown). The brush is mounted on a surface opposite to the sensor substrate 116 of an output gear 21 (see FIG. 1), which is a constituent element of the speed reducing mechanism 18, and rotates integrally with the output shaft 20.

Similar to the first terminal 34 and the like, the sensor terminals 118A to 118C are each a molded component obtained when a wire rod having an electric conductivity is subjected to a forming processing, for instance. The sensor terminals 118A to 118C are arranged side by side in the front-back direction Y. Each of the sensor terminals 118A to 118C is such that one end thereof in the lateral direction X (a middle upper part in FIG. 9) is inserted into a through-hole 120 formed in the sensor substrate 116 and then bonded by the solder (not shown). Thereby, the sensor terminals 118A to 118C are electrically connected to the rotation sensor 114. Similar to the first terminal 34 and the like, each of the sensor terminals 118A to 118C is such that an external connector is provided in the other end thereof in the lateral direction X (a lower part in FIG. 9).

The holder 32 includes a plurality of engaging projections that project upward from the second base 74. The engaging projections 122 are provided at intervals in the front-back direction Y. Engaging holes 124 are formed in the sensor substrate 116 at a right front side and a right rear side.

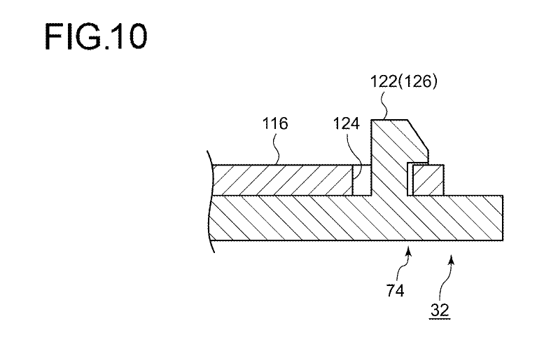

FIG. 10 is a cross-sectional view taken along the line D-D of FIG. 9.

The engaging projection 122 is inserted into the engaging hole 124, and the sensor substrate 116 is secured to the holder 32 through the engagement with each engaging projection 122 by using snap-fit connection. The above-described engaging hole 124 constitutes a fixing portion 126 for fixing the rotation sensor 114 in a detachable manner by the snap-fit connection.

Now refer back to FIG. 9. The holder 32 includes a third holding portion 130 for holding each of the sensor terminals 118A to 118C. A plurality of third holding portions 130 are formed such that they are arranged side by side, in the front-back direction Y, in the second base 74 of the holder 32. The sensor terminals 118A to 118C are inserted into a plurality of third holding portions 130, respectively. Each of the third holding portions 130 are formed by swaging a part of the holder 32.

By employing the above-described terminal unit 10, the rotation sensor 114, which used in association with the electric motor 16, in addition to the first terminal 34, the second terminal 36 and the noise countermeasure component 38 are also unitized before the terminal unit 10 is assembled inside the housing 14. This further improves the workability during an assembly work where the terminal unit 10 is assembled inside the housing 14.

### Third Embodiment

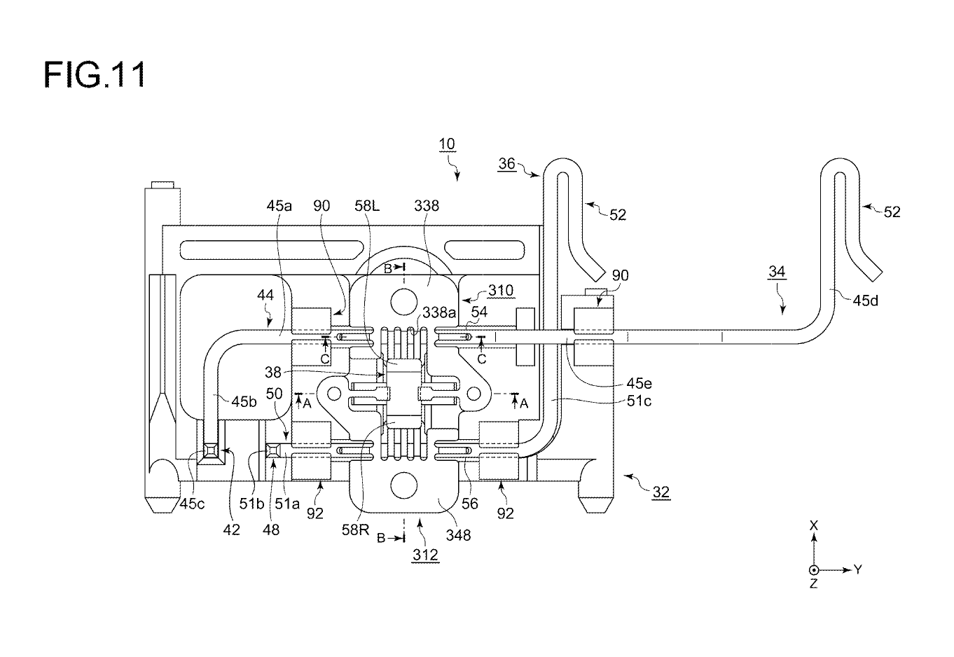

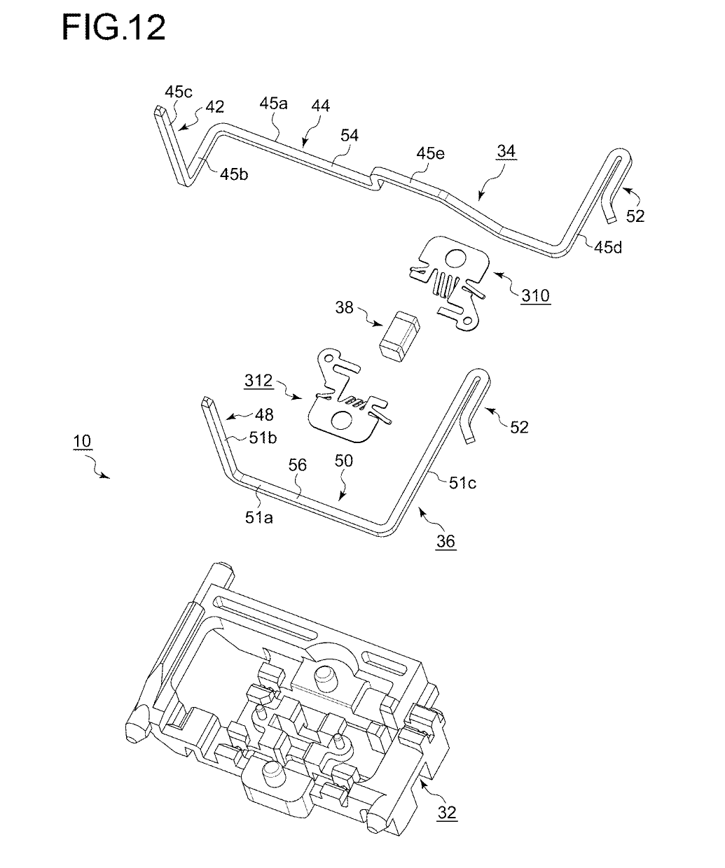

FIG. 11 is a plan view of a terminal unit 10 according to a third embodiment. FIG. 12 is an exploded perspective view of the terminal unit shown in FIG. 11.

The terminal unit 10 according to the first embodiment uses the solder H as the electric conductor that connects between each of the first and second terminals 34 and 36 and each of the external electrodes 58 of the noise countermeasure component 38. The terminal unit 10 according to the third embodiment is characterized by one of main features that a left conductive member 310 (first conductive member) and a right conductive member 312 (second conductive member) are used as the electric conductors. Also, the terminal unit 10 according to the third embodiment is characterized by another one of main features that each of the conductive members 310 and 312 connects to and conducts to each of the external electrodes 58 of the noise countermeasure component 38 by using an elastic restoring force (spring force). A detailed description is given hereunder.

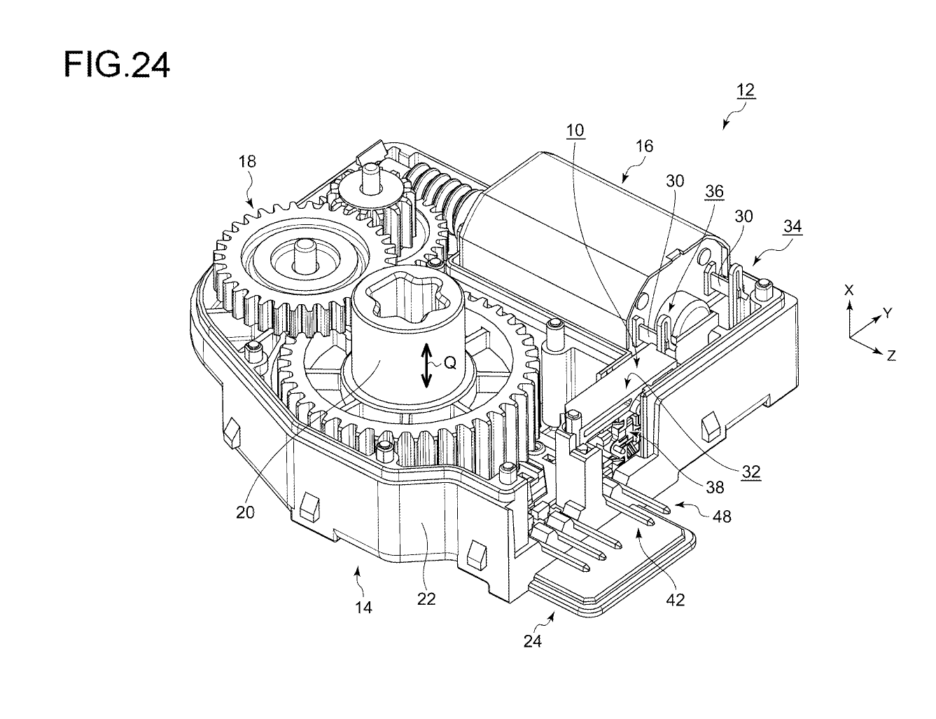

In addition to the holder 32, the first terminal 34, the second terminal 36 and the noise countermeasure component 38, the terminal unit 10 includes the left conductive member 310 and the right conductive member 312. A description is first given of the first terminal 34 and the second terminal 36. As will be discussed later, the terminal unit 10 is contained in the housing 14 in state where the lateral direction X of the holder 32 is aligned not to a shaft-orthogonal direction of the output shaft 20 but to an axis direction Q (see FIG. 24). To realize this, the shape of each of the terminals 34 and 36 differs, as follows, from that in the first embodiment.

Similar to the first embodiment, the first terminal 34 includes a motor connector 52, a first external connector 42, and a first intermediate portion 44. Similar to the first embodiment, the second terminal 36 has a motor connector 52, a second external connector 48, and a second intermediate portion 50. Each of the motor connectors and each of the external connectors 42 and 48 are similar to those in the first embodiment.

The first intermediate portion 44 has a first part 45a that extends in the front-back direction Y, a second part 45b that extends rightward from a rear end of the first part 45a, a third part 45c that extends upward from a lateral end of the second part 45b, and a fourth part 45d that extends leftward from a front end of the first part 45a. A bypass section 45e, which is so provided as to circumvent the second intermediate portion 50 of the second terminal 36, is provided at an intermediate position of the first part 45a. The first external connector 42 is provided at an upper end of the third part 45c. The motor connector 52 is provided at a left end of the fourth part 45d.

The second intermediate portion 50 has a first part 51a that extends in the front-back direction Y, a second part 51b that extends upward from a rear end of the first part 51a, and a third part 51c that extends leftward from a front end of the first part 51a. The second external connector 48 is provided at an upper end of the second part 51b. The motor connector 52 is provided at a left end of the third part 51c.

Similar to the first embodiment, the left connected part 54 is provided at an intermediate position of the first intermediate portion 44 of the first terminal 34, and the right connected part 56 is provided at an intermediate position of the second intermediate portion 50 of the second terminal 36.

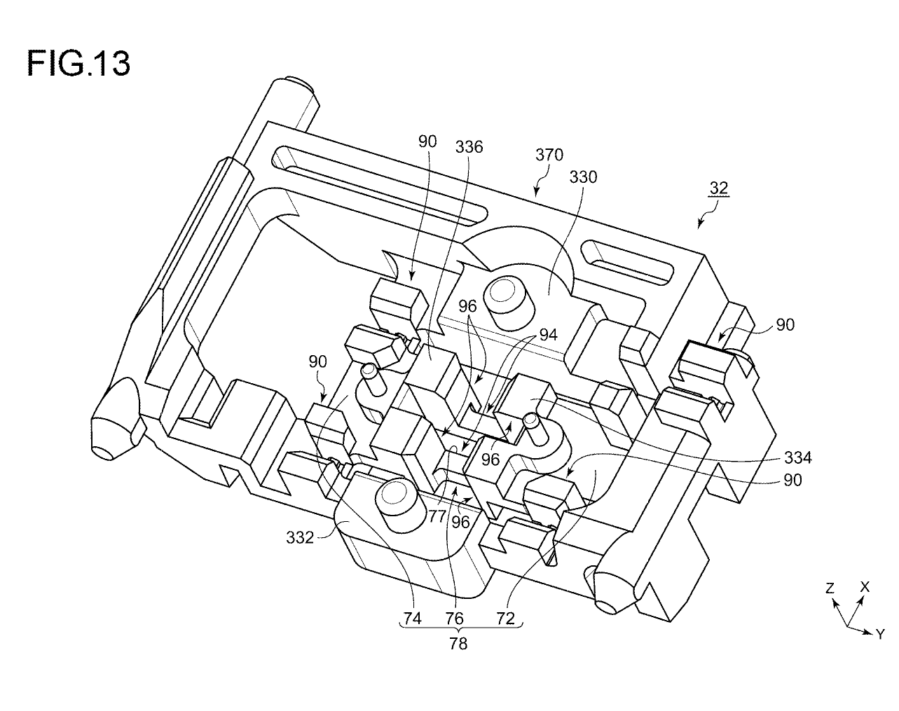

FIG. 13 is a perspective view of a terminal holder 32.

Similar to the first embodiment, the holder 32 includes a holder body 78. This holder body 78 has a first base 72 provided at a front side, a second base 74 provided at a rear side, and a receiving portion 76 provided between the first base 72 and the second base 74.

The holder 32 includes a plurality of first holding portions 90 for holding the first intermediate portion 44 of the first terminal 34, and a plurality of second holding portions 92 for holding the second intermediate portion 50 of the second terminal 36. One of the first holding portions 90 is formed on a left side of the first base 72, and another one of the first holding portions 90 is also formed on a left side of the second base 74. One of the second holding portions 92 is formed on a right side of the first base 72, and another one of the second holding portions 92 is also formed on a right side of the second base 74. Similar to the first embodiment, the intermediate portions 44 and 50 of the terminals 34 and 36, respectively, are inserted into the first holding portion 90 and the second holding portion 92, respectively. The first holding portion 90 and the second holding portion 92 are each formed such that a part of the holder 32 is swaged. FIG. 13 shows a state before the part of the holder 32 is swaged.

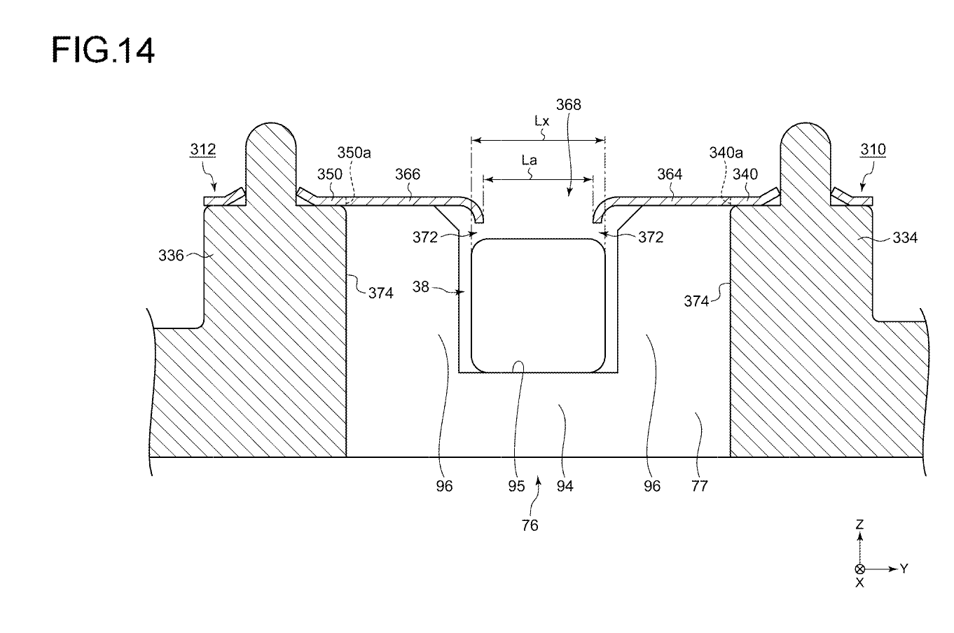

FIG. 14 is a cross-sectional view taken along the line A-A of FIG. 11.

Similar to the first embodiment, as shown in FIG. 13 and FIG. 14, the receiving portion 76 of the holder 32 is open upward and is formed into a groove shape that extends in the lateral direction X. Also, the receiving portion 76 has a bottom wall 94 where a receiving surface 95 is provided, and a pair of side walls 96 that upstand from both front and rear ends of the receiving surface 95. In the present embodiment, a notch (cutout) 77, which extends in the front-back direction X at an intermediate position in the lateral direction Y, is formed in the receiving portion 76; the receiving portion 76 is of a shape such that the receiving portion 76 is divided by the notch 77 in the lateral direction Y.

As shown in FIG. 13, the holder 32 includes a left seat 330 (first seat) that connects the first base 72 and the second base 74 on the left side relative to the receiving portion 76, and a right seat 332 (second seat) that connects the first base 72 and the second base 74 on the right side relative to the receiving portion 76. Also, the holder 32 includes a front seat 334 (third seat) that is formed, between the first base 72 and the receiving portion 76, on the front side relative to the receiving portion 76, and a rear seat 336 (fourth seat) that is formed, between the second base 74 and the receiving portion 76, on the rear side relative to the receiving portion 76. Each of the seats 330, 332, 334 and 336 is formed such that the seat protrudes upward with respect to the first base 72 and the second base 74.

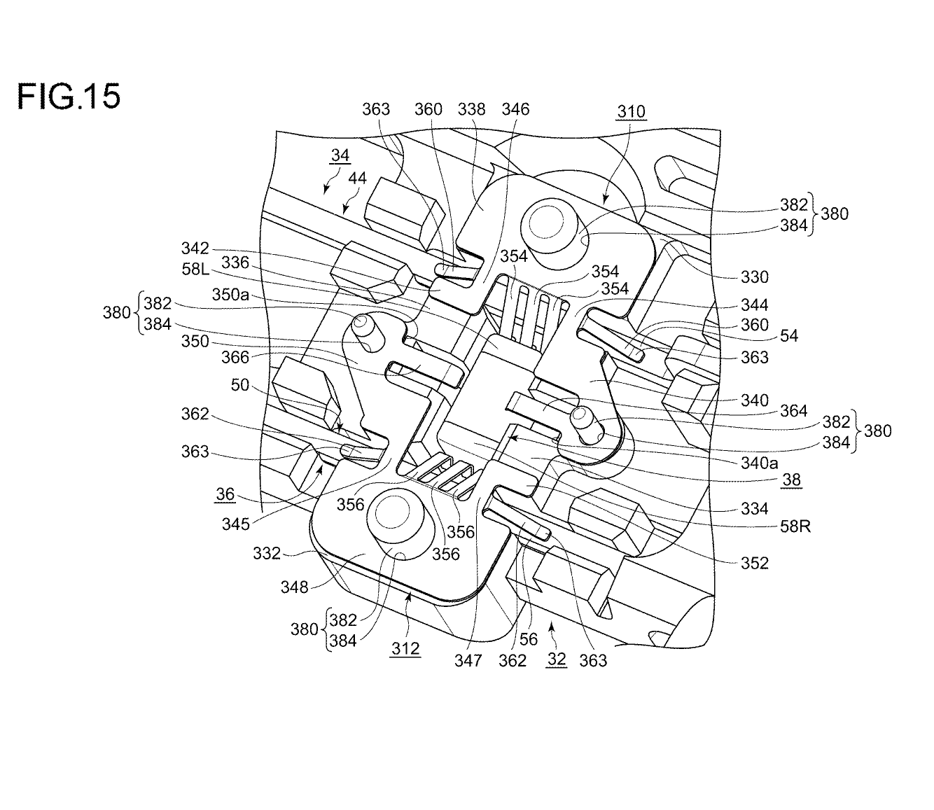

FIG. 15 is a perspective view of an enlarged part of the terminal unit 10.

The first intermediate portion 44 of the first terminal 34 is arranged between the left seat 330 and each of the front seats 334 and the rear seat 336 of the holder 32. The second intermediate portion 50 of the second terminal 36 is arranged between the right seat 332 and each of the front seats 334 and the rear seat 336 of holder 32.

The left conductive member 310 electrically connects the left connected part 54 of the first terminal 34 and the left external electrode 58L of the noise countermeasure component 38. The right conductive member 312 electrically connects the right connected part 56 of the second terminal 36 and the right external electrode 58R of the noise countermeasure component 38.

Each of the conductive members 310 and 312, which is made of a material having electric conductivity and spring characteristic, is a molded component obtained such that the constituting parts thereof are integrally formed with each other by using a punching process or the like. The left conductive member 310 and the right conductive member 312 are constructed by using a common part or parts. More specifically, when the left conductive member 310 is rotated by 180° about the center point thereof in a top surface view (the same viewpoint as FIG. 11), the right conductive member 312 is such that the relative positional relationship of the constituting parts becomes the same as that of the left conductive member 310. From a different point of view, the left conductive member 310 and the right conductive member 312 have shapes that are point-symmetrical about the center point. Thereby, a part or parts is/are shared by the left conductive member 310 and the right conductive member 312 so as to suppress the number of components used, so that the product cost can be reduced. Also, the contact pressures of electrode contact parts 354 and 356 (described later) of the conductive members 310 and 312, respectively, against the external electrodes 58 as well as the contact pressures of terminal contact parts 360 and 362 (described later) of the conductive members 310 and 312, respectively, against the terminals 34 and 36 are stabilized.

The left conductive member 310 has a left mounted part 338 (first mounted part) that is mounted on the left seat 330 of the holder 32, a front mounted part 340 (first mounted part) that is mounted on the front seat 334 of the holder 32, and a rear supported part 342 (first supported part) that is supported by the rear seat 336 of the holder 32. Also, the left conductive member 310 has a first construction part 344 that is constructed between the left mounted part 338 and the front mounted part 340, and a second construction part 346 that is constructed between the left mounted part 338 and the rear supported part 342. The first construction part 344 and the second construction part 346 are arranged above the first intermediate portion 44 of the first terminal 34 in such a manner as to lie across the first intermediate portion 44 thereof in the lateral direction X.

The right conductive member 312 has a right mounted part 348 (second mounted part) that is mounted on the right seat 332 of the holder 32, a rear mounted part 350 (second mounted part) that is mounted on the rear seat 336 of the holder 32, and a front supported part 352 (second supported part) that is supported by the front seat 334 of the holder 32. Also, the right conductive member 312 has a third construction part 345 that is constructed between the right mounted part 348 and the rear mounted part 350, and a fourth construction part 347 that is constructed between the right mounted part 348 and the front supported part 352. The third construction part 345 and the fourth construction part 347 are arranged above the second intermediate portion 50 of the second terminal 36 in such a manner as to lie across the second intermediate portion 50 thereof in the lateral direction X.

The conductive members 310 and 312 are assembled to the seats 330, 332, 334 and 336 of the holder 32 by using an assembled structure 380. Moreover, the assembled structure 380 includes a protrusion 382 that protrudes upward on each of the seats 330, 332, 334 and 336 of the holder 32, and a hole portion 384 that is formed in each of the mounted parts 338, 340, 348 and 350 of the conductive members 310 and 312. The protrusions 382 of the holder 32 are fitted into and press-fitted to the hole portions 384 of the conductive members 310 and 312; this assembles each of the conductive members 310 and 312 to the holder 32. Note that the assembled structure 380 may be constructed such that the protrusion 382 is firmly retained in the hole portion 384 of each of the conductive members 310 and 312 by swaging the protrusion 382.

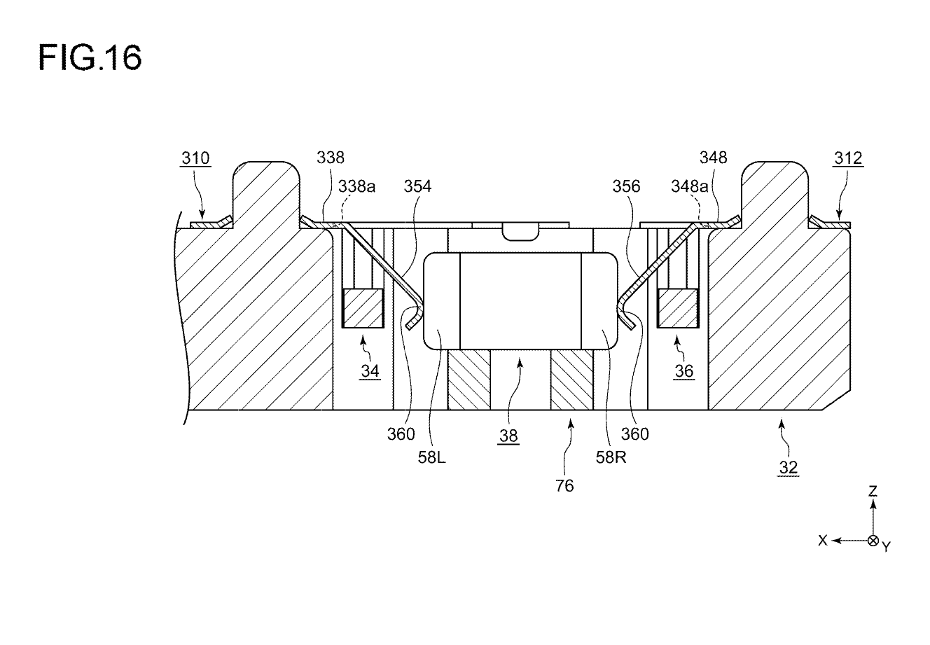

FIG. 16 is a cross-sectional view taken along the line B-B of FIG. 11.

The left mounted part 338 of the left conductive member 310 is arranged on one side (left side) of the noise countermeasure component 38 in the lateral direction X, and the right mounted part 348 of the right conductive member 312 is arranged on the other side (right side) of the noise countermeasure component 38 in the lateral direction X. The left mounted part 338 of the left conductive member 310 has a right-end edge part 338a, and the right mounted part 348 of the right conductive member 312 has a left-end edge part 348a. The right-end edge part 338a of the left conductive member 310 and the left-end edge part 348a of the right conductive member 312 are located opposite to each other in the lateral direction X.

The left conductive member 310 further includes a left electrode contact part 354 (first electrode contact part) that is in contact with the left external electrode 58L of the noise countermeasure component 38. The left electrode contact part 354 has a plate-like shape that extends toward a lower side from the right-end edge part 338a of the left mounted part 338. Also, the right conductive member 312 further includes a right electrode contact part 356 (second electrode contact part) that is in contact with the right external electrode 58R of the noise countermeasure component 38. The right electrode contact part 356 has a plate-like shape that extends toward the lower side from the left-end edge part 348a of the right mounted part 348. A plurality of left electrode contact parts 354 (there are three of them in FIG. 15) are arranged and formed side by side in the front-back direction Y; similarly, a plurality of right electrode contact parts 356 (there are three of them in FIG. 15) are arranged and formed side by side in the front-back direction Y.

The left electrode contact part 354 and the right electrode contact part 356 are each formed such that the interval, between the inner side surfaces of the left and right electrode contact parts 354 and 356 facing each other in the lateral direction X, gets narrower toward the lower side of the height direction Z. Also, a bent part 360, which is a protrusion pointing inward in the lateral direction X, is formed in a tip-side portion of each of the left electrode contact part 354 and the right electrode contact part 356. The inner side surface of the bent part 360 of the left electrode contact part 354 is in contact with the left external electrode 58L of the noise countermeasure component 38, and the inner side surface of the bent part 360 of the right electrode contact part 356 is in contact with the right external electrode 58R thereof.

As discussed earlier, each of the conductive members 310 and 312 is made of a material having the spring characteristic, and each of the electrode contact parts 354 and 356 functions as an elastically deformable plate spring. Each of the electrode contact parts 354 and 356 is movable toward and away from each of the external electrodes 58 of the noise countermeasure component 38 when the tip-end portion of each of the electrode contact parts 354 and 356 is turned in the periphery of a base end of each of the electrode contact parts 354 and 356 (in the periphery of each of the end edge parts 338a and 348a of the conductive members 310 and 312). The terms “being movable toward and away from” as used herein indicate being contactable with and separable away from.

The left electrode contact part 354 and the right electrode contact part 356 are each in an elastically deformed state in the lateral direction X that enlarges the inner side surfaces of both the left and right electrode contact parts 354 and 356. Thereby, their own elastic deformation causes an elastic restoring force to be applied to or exerted on the left electrode contact part 354 and the right electrode contact part 356 in the lateral direction X that narrows both the inner side surfaces thereof. Each of the electrode contact parts 354 and 356 is pressed against each of the external electrodes 58, which are to be connected, by the elastic restoring force. As a result, the left electrode contact part 354 and the right electrode contact part 356 apply the elastic restoring forces, by which the noise countermeasure component 38 is interposed between the both sides thereof in the lateral direction X, to the noise countermeasure component 38. The noise countermeasure component 38 maintains its position relative to the receiving portion 76 of the holder 32 by the elastic restoring force given by each of the conductive members 310 and 312.

FIG. 17 is a cross-sectional view taken along the line C-C of FIG. 11. In FIG. 17, only the left conductive member 310 and part of the first terminal 34 are shown, and any other intermediate parts in the front-back direction Y are omitted.

As shown in FIG. 15 and FIG. 17, the left conductive member 310 further includes a plurality of first terminal contact parts 360 that are in contact with the left connected part 54 of the first terminal 34. One of the first terminal contact parts 360 has a plate-like shape that extends toward a lower side, in the height direction Z, from a front-end edge part of the first construction part 344 of the left conductive member 310. Another one of the first terminal contact parts 360 has a plate-like shape that extends toward the lower side, in the height direction Z, from a rear-end edge part of the second construction part 346 of the left conductive member 310. The plurality of first terminal contact parts 360 are each formed such that the interval, between the inner side surfaces thereof facing each other in the front-back direction Y, gets wider toward the lower side of the height direction Z. Also, a bent part 364, which is a protrusion pointing toward a lower side of the height direction Z, is formed in a tip-side portion of the first terminal contact part 360.

As shown in FIG. 15, the right conductive member 312 further includes a plurality of second terminal contact parts 362 that are in contact with the right connected part 56 of the second terminal 36. The second terminal contact part 362 has a plate-like shape similar to that of the first terminal contact part 360 of the left conductive member 310.

Similar to each of the electrode contact parts 354 and 356, each of the terminal contact parts 360 and 362 functions as an elastically deformable plate spring. Each of the terminal contact parts 360 and 362 is also pressed against the first terminal 34 or the second terminal 36, which is to be connected, by the elastic restoring force applied to each of the terminal contact parts 360 and 362 themselves.

By employing the above-described terminal unit 10, the electrode contact parts 354 and 356 of the conductive members 310 and 312, respectively, are pressed against the external electrodes 58, to be connected, of the noise countermeasure component 38 by the elastic restoring force. Thus, the electrode contact parts 354 and 356 of the conductive members 310 and 312, respectively, can come in contact with the external electrodes 58 of the noise countermeasure component 38 by using the elastic restoring forces and thereby electrically conduct to the external electrodes 58 thereof, so that the number of solder joints can be reduced. Thus, the present embodiment provides the terminal unit 10 having a configuration suitable for the reduction of the number of solder joints, when the first terminal 34 and the second terminal 36 are electrically connected to the nose countermeasure component 38. Also, since the number of solder joints can be reduced, the occurrence of malfunctions caused by the solder bonding can be prevented. Here, the “malfunctions” are, for example, cracks that occur as a result of the stress applied to the solder joints.

Also, since the electrode contact parts 354 and 356 of the conductive members 310 and 312, respectively, are pressed against the external electrodes 58 of the noise countermeasure component 38 by using the elastic restoring force, a structure that can allow the dimensional tolerance is realized. Thus, even though the noise countermeasure component 38 has a dimensional tolerance, the electrode contact parts 354 and 356 can be brought into contact with the external electrodes 58 of the noise countermeasure component 38 in a stabilized manner. Note here that in the present embodiment the dimensional tolerance indicates the dimensional tolerance of the noise countermeasure component 38 in the lateral direction X.

(A) Also, the electrode contact parts 354 and 356 of the conductive members 310 and 312, respectively, apply the elastic restoring forces to the noise countermeasure component 38 such that the noise countermeasure component 38 is interposed between the both sides thereof in the lateral direction X. Thus, even though the noise countermeasure component 38 is displaced relative to the holder 32 in a wobbling manner due to vibration or the like, the electrode contact parts 354 and 356 can be displaced by following the displacement movement of the noise countermeasure component 38 while the electrode contact parts 354 and 356 remain in contact with the external electrodes 58L and 58R of the noise countermeasure component 38, respectively. For this reason, even if the noise countermeasure component 38 is displaced relative the holder 32, the noise countermeasure component 38 will be more likely to remain electrically connected to the first terminal 34 and the second terminal 36. This can improve the connection reliability of the noise countermeasure component to each of the terminals 34 and 36.

Also, the terminal contact parts 360 and 362 of the conductive members 310 and 312 are pressed against the connected part 54 and 56 of the terminals 34 and 36, respectively, which are to be connected, by the elastic restoring force. Thus, the terminal contact parts 360 and 362 of the conductive members 310 and 312 can come in contact with the connected part 54 and 56 of the terminals 34 and 36, respectively, by using the elastic restoring forces and thereby electrically conduct to the connected parts 54 and 56 thereof, so that the number of solder joints can be further reduced. This can not only improve the workability during the assembly work but also reduce the occurrence of malfunctions caused by the solder bonding.

A description is now given of other features of the terminal unit 10 according to the present embodiment.

As shown in FIG. 14 and FIG. 15, the front mounted part 340 of the left conductive member 310 is arranged on one side (front side) of the front-back direction Y relative to the noise countermeasure component 38. The rear mounted part 350 of the right conductive member 312 is arranged on the other side (rear side) of the front-back direction relative to the noise countermeasure component 38. The front mounted part 340 of the left conductive member 310 has a rear-end edge part 340a, and the rear mounted part 350 of the right conductive member 312 has a front-end edge part 350a. The rear-end edge part 340a of the left conductive member 310 and the front-end edge part 350a of the right conductive member 312 are located opposite to each other in the front-back direction Y.

The left conductive member 310 has a front displacement regulating part 364 (first displacement regulating part) that is of a plate-like shape that extends from the rear-end edge part 340a of the left conductive member 310 toward a rear side. The right conductive member 312 has a rear displacement regulating part 366 (second displacement regulating part) that is of a plate-like shape that extends from the front-end edge part 350a of the right conductive member 312 toward a front side. The front displacement regulating part 364 and the rear displacement regulating part 366 are arranged opposite to each other in the front-back direction Y with a spacing 368 being formed therebetween to allow the noise countermeasure component 38 to be passed therethrough.

Each of the displacement regulating parts 364 and 366 is provided in order that a displacement in a direction (upper side) separated away from the receiving portion 76 of the noise countermeasure component 38 can be regulated by the engagement of the displacement regulating parts 364 and 366 with the noise countermeasure component 38. In order to achieve such a function, each of the displacement regulating parts 364 and 366 is so arranged as to be located opposite to (upper side of) the receiving portion 76 with respect to the noise countermeasure component 38. Also, an interval La between tip portions of the displacement regulating parts 364 and 366 is so formed as to be smaller than a front-back size Lx of the noise countermeasure component 38. With this configuration and arrangement, even though an upward force is exerted on the noise countermeasure component 38 by the electrode contact parts 354 and 356 of the conductive members 310 and 312, respectively, the engagement of the noise countermeasure component 38 with the displacement regulating parts 364 and 366 can prevent the floating or uplift of the noise countermeasure component 38. As a result, the noise countermeasure component 38 is more likely to be kept at a fixed position in a stabilized manner.

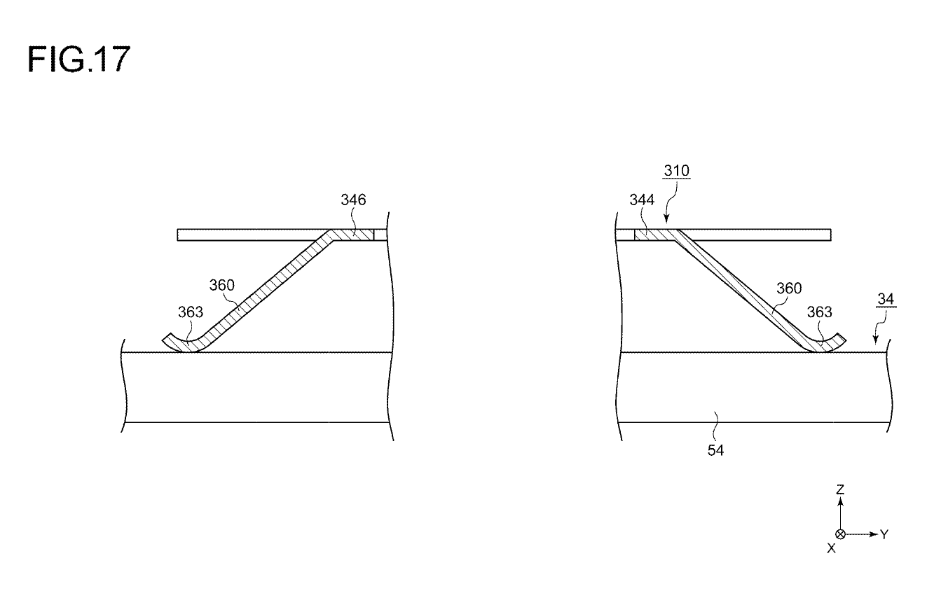

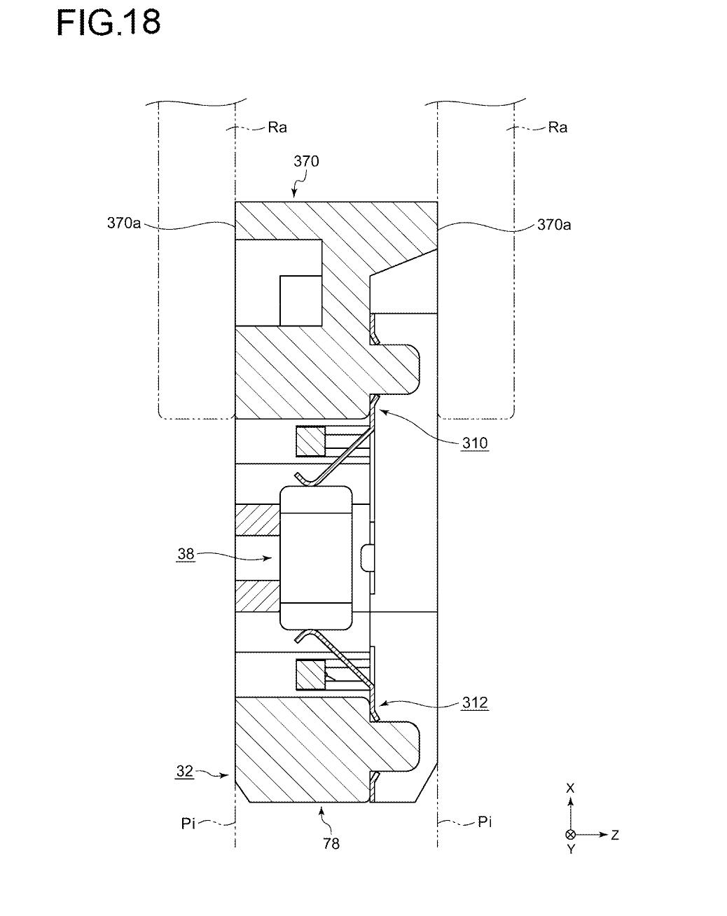

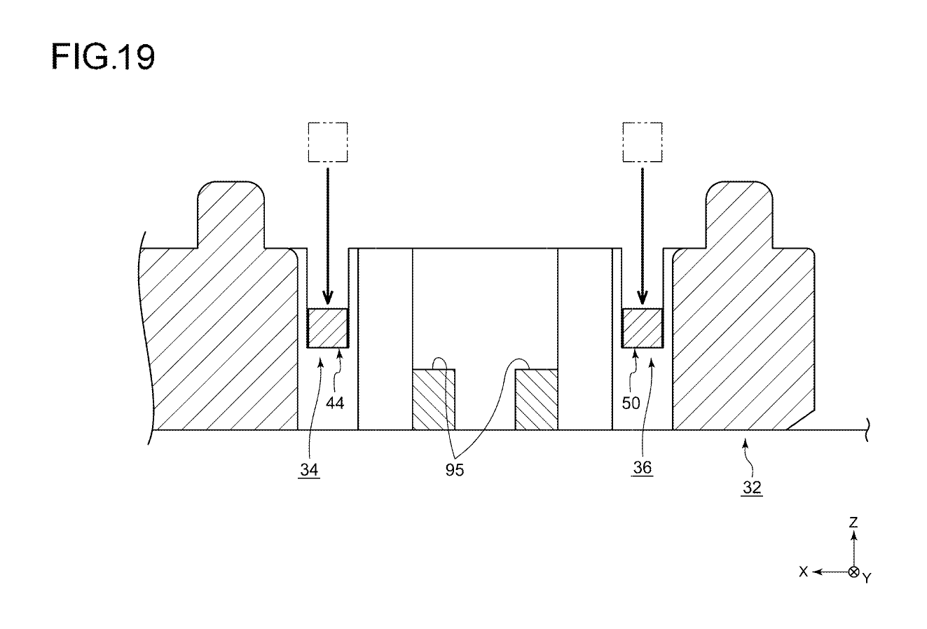

FIG. 18 is a cross-sectional view of an entire terminal unit 10 as viewed from the same viewpoint as FIG. 16.

As shown in FIG. 13 and FIG. 18 and as discussed earlier, the holder 32 includes the holder body 78, which has the first base 72, the second base 74, and the receiving portion 76. In the holder body 78, a gripper portion 370, which extends along the front-back direction Y, is formed at an edge portion of one side (left side) of the lateral direction X. The gripper portion 370 is so formed as to be located on the left side with respect to the first base 72, the second base 74 and the receiving portion 76. Similar to the gripper portion 100 according to the first embodiment, the gripper portion 370 is provided so that the gripper portion 370 can be grasped by a robot arm Ra and the like when the terminal unit 10 including the holder 32 is handled. Since the gripper portion 370 according to the present embodiment is formed at the edge portion of the holder body 78, the length of the gripper portion 370 in the front-back direction can be increased, thereby making it easy for the operator and the like to grasp the gripper portion 370.

The noise countermeasure component 38, the left conductive member 310 and the right conductive member 312 are so arranged as to be contained inside the height direction Z by a pair of virtual surfaces Pi passing through both side surfaces 370a of the gripper portion 370 in the height direction Z. In other words, it can be said that the noise countermeasure component 38 and the like are arranged such that these component and members do not extend or protrude from the pair of virtual surface Pi in the height direction Z. This can prevent the operator's fingers or the like from coming in contact with the noise countermeasure component 38 and each of the conductive members 310 and 312, when the gripper portion 370 of the holder 32 is grasped.

A description is given of a method for assembling the above-described terminal unit 10.

The holder 32 is first placed on top of the work table or the like such that the receiving surface 95 of the holder 32 is located toward the upper side in the vertical direction. Then, the intermediate portions 44 and 50 of the terminals 34 and 36, respectively, are placed inside grooves (not shown) that form the basis of the holding portions 90 and 92 of the holder 32. After this, part of the periphery of the grooves of the terminals 34 and 36 are swaged; thereby, each of the holding portions 90 and 92 is formed, and the terminals 34 and 36 are held by the holding portions 90 and 92, respectively.

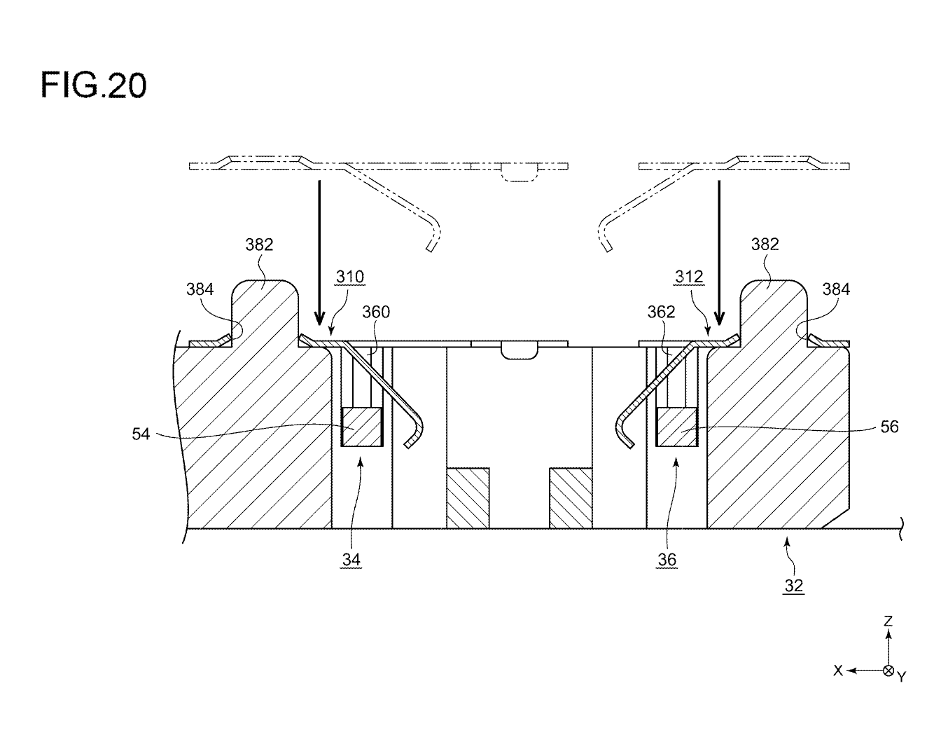

Then, as shown in FIG. 20, the left conductive member 310 and the right conductive member 312 are displaced in the lower side of the height direction Z. Thereby, the protrusions 382 of the holder 32 are press-fitted into the hole portions 384 of the conductive members 310 and 312; this assembles each of the conductive members 310 and 312 to the holder 32. As a result, the terminal contact parts 360 and 362 of the conductive members 310 and 312, respectively, are brought into contact with the connected part 54 and 56 of the terminals 34 and 36, respectively.

As described above, the holder 32 is configured such that the first terminal 34, the second terminal 36, the left conductive member 310 and the right conductive member 312, respectively, can be arranged in positions that are to be held by the holder 32 when each of them is displaced on the lower side of the height direction Z.

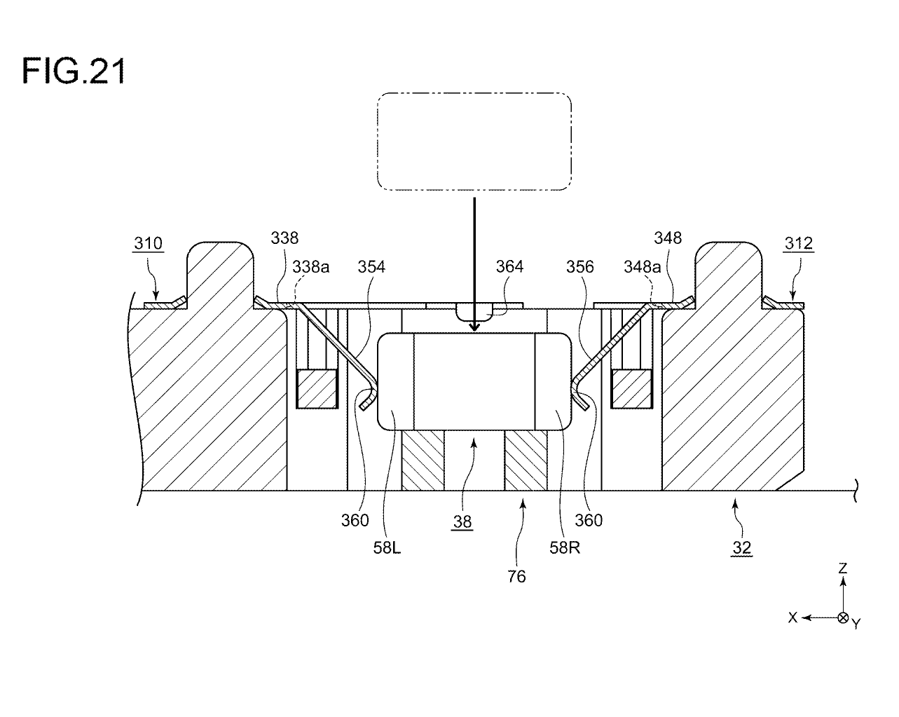

Then, as shown in FIG. 21, the noise countermeasure component 38 is displaced on the lower side of the height direction Z so that the noise countermeasure component 38 passes through the spacing between the electrode contact parts 354 and 356 of the conductive member 310 and 312. At this time, as shown in FIG. 14, the noise countermeasure component 38 is displaced on the lower side of the height direction Z so that the noise countermeasure component 38 also passes through the spacing between the displacement regulating parts 364 and 366 of the conductive member 310 and 312. Now refer back to FIG. 21. The noise countermeasure component 38 is kept to be displaced until when the noise countermeasure component 38 is placed on the receiving portion 76 of the holder. As a result, the noise countermeasure component 38 is arranged in a position that is to be held by the electrode contact parts 354 and 356 of the conductive member 310 and 312.

As described above, the left electrode contact part 354 of the left conductive member 310 and the right electrode contact part 356 of the right conductive member 312 is configured such that the noise countermeasure component 38 can be arranged in a position that is to be held by the electrode contact parts 354 and 356 when the noise countermeasure component 38 is displaced on the lower side of the height direction Z.

As described above, the holder 32 is configured such that assembling direction, relative to the holder 32, of respective of the terminals 34 and 36 and the conductive members 310 and 312 as well as the noise countermeasure component 38 are on lower sides of the height direction Z. Thus, the assembly work can be done, without reversing the direction of the holder 32 in the height direction, during an assembly work; this improves the workability during the assembly work.

Also, as shown in FIG. 14, each of the displacement regulating parts 364 and 366 is arranged such that a spacing 372 is formed between each thereof and the noise countermeasure component 38 in the height direction Z. This configuration and arrangement make it easy for each of the displacement regulating parts 364 and 366 to return to a position before the deformation, when the noise countermeasure component 38 is moved downward through between the displacement regulating parts 364 and 366 of the conductive members 310 and 312 and when each of the displacement regulating parts 364 and 366 is so elastically deformed as to enlarge the interval between their mutual inner side surfaces. This facilitates arranging the displacement regulating parts 364 and 366 of the conductive members 310 and 312 in an upper side of the noise countermeasure component 38 and thereby facilitates stably achieving the functions of the displacement regulating parts 364 and 366. Note that a notch (cutout) 374 is formed in the front seat 334 and the rear seat 336 of the holder 32. The notch 374 is used to allow the displacement of the displacement regulating parts 364 and 366 in the height direction Z.

Also, as shown in FIG. 21, the electrode contact parts 354 and 356 of the conductive members 310 and 312 extend toward a lower side from the edge parts 338a and 348a of the conductive members 310 and 312, respectively, and are formed such that the interval, between the inner side surfaces of the electrode contact parts 354 and 356 facing each other in the lateral direction X, gets narrower toward the lower side. As a result, the following advantageous effects are achieved.

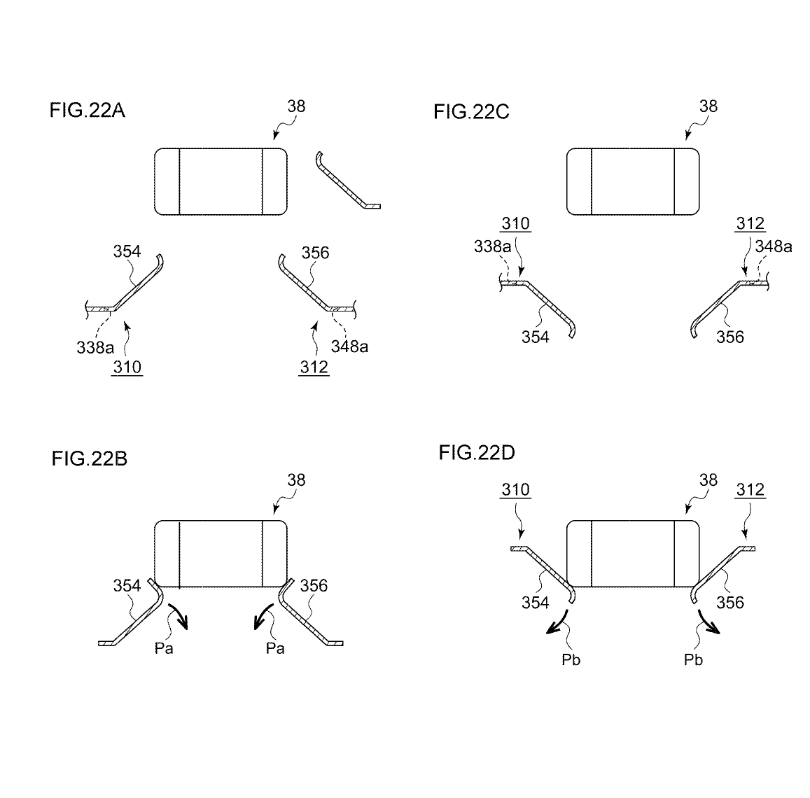

As shown in FIG. 22A, consider a case where the electrode contact parts 354 and 356 of the conductive members 310 and 312 extend toward an upper side from the end edge parts 338a and 348a of the conductive members 310 and 312, and are formed such that the interval, between the inner side surfaces thereof, gets narrower toward the upper side. In this case, as shown in FIG. 22B, it is assumed here that when the noise countermeasure component 38 is moved downward through between the electrode contact parts 354 and 356 of the conductive members 310 and 312, each of the electrode contact parts 354 and 356 of the conductive members 310 and 312 is also deformed in a downward direction Pa together with the noise countermeasure component 38. At this time, the electrode contact parts 354 and 356 of the conductive members 310 and 312 tend to be deformed in such a manner as to narrow the interval between their mutual inner side surfaces. On the other hand, the noise countermeasure component 38 acts as a stiff component that restricts the deformation of each of the electrode contact parts 354 and 356. As a result, the noise countermeasure component 38 is less likely to be displaced toward a lower side until when the noise countermeasure component 38 is placed on the receiving portion 76 of the holder 32.

(B) In contrast to this, consider now a configuration, according to the third embodiment, as shown in FIG. 22C. In this case, as shown in FIG. 22D, when the noise countermeasure component 38 is moved downward through between the electrode contact parts 354 and 356 of the conductive members 310 and 312, each of the electrode contact parts 354 and 356 of the conductive members 310 and 312 can be so deformed in a direction Pb as to enlarge the interval between their mutual inner side surfaces. Thus, when the noise countermeasure component 38 is assembled to the holder 32, the noise countermeasure component 38 is likely to be displaced toward the lower side until when the noise countermeasure component 38 is placed on the receiving portion of the holder 32 and thereby the workability during the assembly work improves.

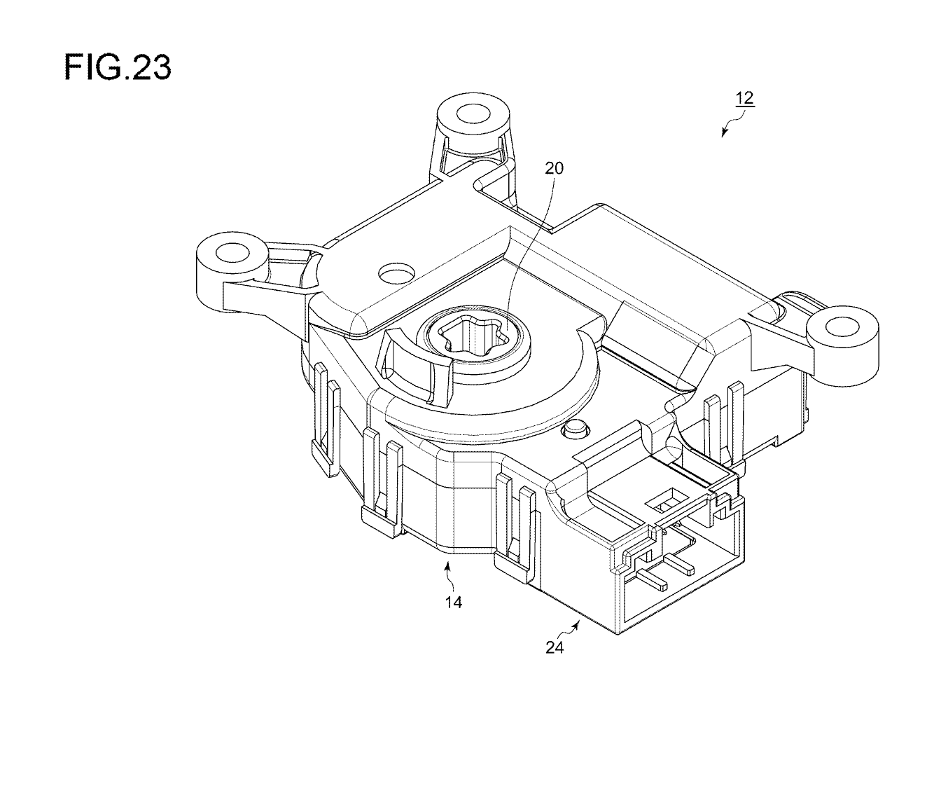

A description is now given of the actuator 12 using the above-described terminal unit 10. FIG. 23 is a perspective view of an actuator 12 according to the third embodiment. FIG. 24 is an exploded perspective view of the actuator 12.

As discussed earlier, the actuator 12 includes a housing 14 and an output shaft 20 rotated by the rotation of an electric motor 16 contained in the housing 14. The output shaft 20 is provided such that one end of the output shaft 20 is exposed to the outside of the housing 14, and various mechanical devices to be driven are coupled to the output shaft 20.

The terminal unit 10 is contained in the housing 14 such that the lateral direction X of the holder 32 is aligned to the axis direction Q of the output shaft 20 of the actuator 12. Here, “being aligned to” includes that the lateral direction X of the holder 32 is made to agree with the axis direction Q of the output shaft 20 as well as that it is made to almost agree therewith. Advantages for this will be described hereunder.

The terminal unit 10 is such that the first terminal 34 and the second terminal 36 are first arranged side by side in the lateral direction X and then the noise countermeasure component 38 is arranged therebetween. Thus the entire size (dimensions) the terminal unit 10 is more likely to be large. If such a terminal unit 10 is contained in the housing 14 such that the lateral direction X is aligned to the shaft-orthogonal direction of the output shaft 20, a dead space will be more likely to occur in the terminal unit 10 in the axis direction Q of the output shaft 20. This may cause the entire housing 14 to grow larger in size. In this respect, the configuration according to the present embodiment suppresses the size of the dead space occurring in the axis direction Q of the output shaft 20 with respect to the terminal unit 10. Thus, the entire housing 14 is more likely to be smaller-sized as compared with the case where the terminal unit 10 is contained in the housing 14 such that the lateral direction X of the terminal unit 10 is aligned to the shaft-orthogonal direction of the output shaft 20. In particular, the dimensions of the housing 14 in the shaft-orthogonal direction are more likely to be reduced.

While the preferred embodiments of the present invention have been described using specific terms, such description is for the purpose of only illustrating the principle and applications of the present invention. Also, it is to be understood that modifications or changes and variations in arrangement may be made without departing from the spirit or scope of the appended claims that underlie the technical ideas of the present invention.

The first terminal 34 and the second terminal 36 are electrically connected to the electric motor 16 that serves as an electric apparatus but may also be connected to an electric apparatus other than the electric motor 16. Also, a stepping motor or the like other than the DC motor may be used. Also, the description has been given of an example where the first terminal 34 and the second terminal 36 are each a molded component using the wire rod, but a press part or the like may be used instead. Also, the terminal 34 and the second terminal 36 are not limited to those having the configurations and shapes shown in any of the Figures.

It suffices if the noise countermeasure component 38 is an electronic component functioning as a noise filter for suppressing the noise occurring in the power supply line; ferrite bead or the like other than the capacitor may be used. An exemplary case has been described where the noise countermeasure component 38 is a surface-mounted electronic component but an electronic component having the lead component may be used instead.

In the first embodiment, the description has been given of an example where the connected parts 54 and 56 of the terminals 34 and 36, respectively, are bonded to the external electrodes 58, to be connected, of the noise countermeasure component 38 by the solders H that is used as electric conductors. The solder H has been described as an example of electrically conductive bonding material. In addition to this, an electrically conductive adhesive or the like may be used for the electrically conductive bonding material.

It suffices that the holder 32 includes the first holding portion 90, the second holding portion 92, and the receiving portion 76; the gripper portions 100 and 102 and the posture keeping portion 104 may not be included in the holder 32 as with the first embodiment. Also, the gripper portion 370 as in the second embodiment may not be provided at all.

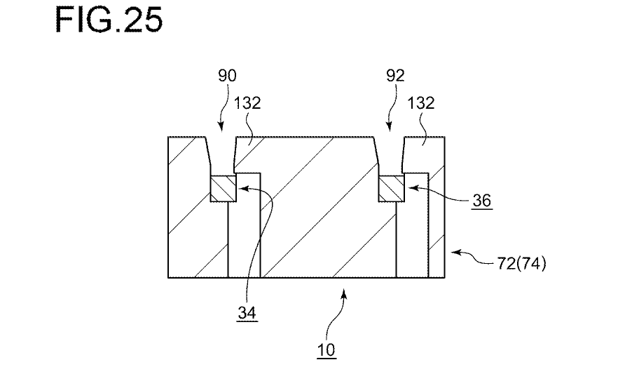

FIG. 25 is a cross-sectional view of a terminal unit 10 according to a first modification. FIG. 25 shows components corresponding to those of FIG. 6.

The first holding portion 90 and the second holding portion 92 have engaging projections 132 that project upward from the bases 72 and 74, respectively. Each of the holding portions 90 and 92 may be held through the engagement of the engaging protrusion 132 with each of the terminals 34, 36 and 118A to 118C by using the snap-fit connection.

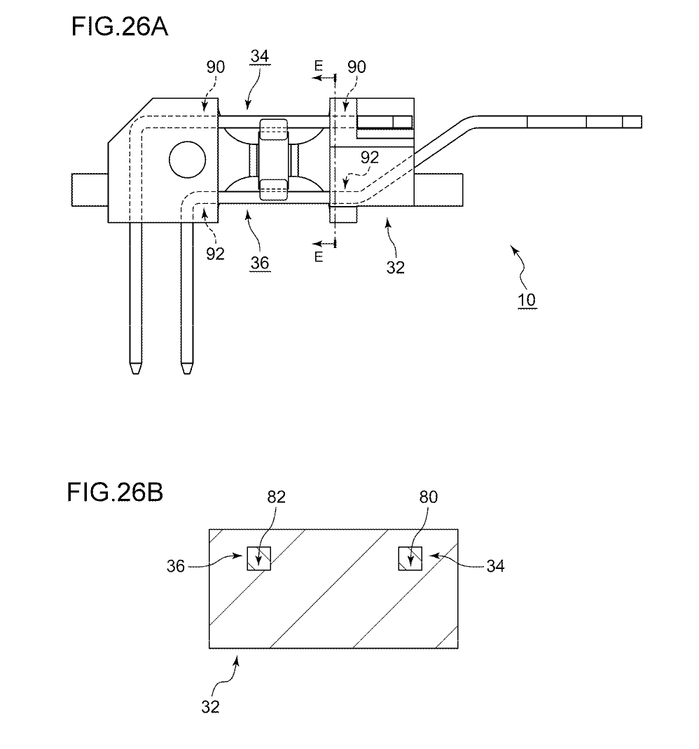

FIG. 26A is a plan view of a terminal unit 10 according to a second modification. FIG. 26B is a cross-sectional view taken along the line E-E of FIG. 26A.

The first holding portion 90 and the second holding portion 92 may be formed by carrying out an insert molding. In this case, a molten resin is poured into a metal mold in a state where each of the terminals 34 and 36 is placed in the metal mold when the holder 32 is resin-molded. Thereby, the holding portions 90 and 92 are molded in a state that each of the terminals 34 and 36 is inserted into each of the holding portions 90 and 92.

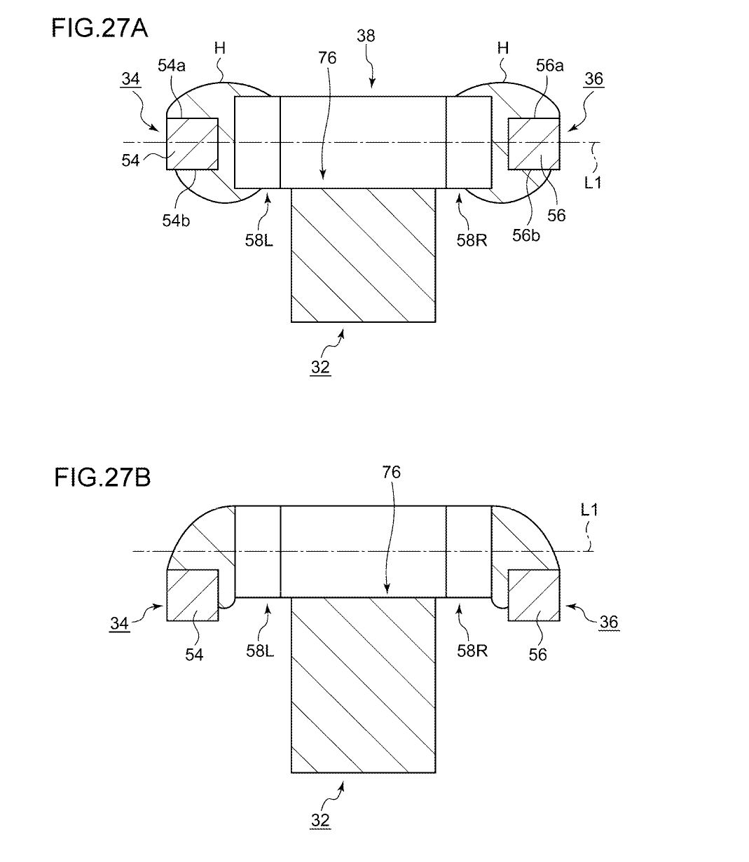

FIG. 27A and FIG. 27B are cross-sectional views of a terminal unit 10 according to a third modification and a fourth modification, respectively, and show components corresponding to those of the cross-sectional surface shown in FIG. 5A.

In the example of FIG. 5A, the description has been given of an example where, in addition to the top faces 54a and 56a of the connected parts 54 and 56 of the terminals 34 and 36, the undersurfaces 54b and 56b are also located in the position above the center position L1 of the noise countermeasure component 38 in the height direction Z. Instead, as shown in FIG. 27A, only the top faces 54a and 56a of the connected parts 54 and 56 of the terminals 34 and 36 may be located in a position above the center position L1 of the noise countermeasure component 38. Also, only the top faces 54a and 56a of either one of the connected parts 54 and 56 of the terminals 34 and 36 may be located in a position above the center position L1 of the noise countermeasure component 38. Also, as shown in FIG. 27B, the noise countermeasure component 38 is preferably arranged between the connected parts 54 and 56 of the terminals 34 and 36, and the top faces 54a and 56a of the connected parts 54 and 56 of the terminals 34 and 36 may be located in a position below the center position L1 of the noise countermeasure component 38.

In either case, the noise countermeasure component 38 is preferably placed between the connected parts 54 and 56 of the terminals 34 and 36. This configuration is now explained in terms of the relationship between the top faces 54a and 56a of the connected parts 54 and 56 and the undersurfaces 54b and 56b thereof. It is preferable that the undersurface of the noise countermeasure component 38 is located below the top faces 54a and 56a of the connected parts 54 and 56 and that the top face of the noise countermeasure component 38 is located above the undersurfaces 54b and 56b of the connected parts 54 and 56.

Also, the description has been given of an example where both of the connected parts 54 and 56 of the terminals 34 and 36 are arranged relative to the noise countermeasure component 38 in the lateral direction X with intervals 98 between the noise countermeasure component 38 and the connected parts 54 and 56. Instead, only one of the connected parts 54 and 56 may be arranged with the interval 98. Also, the clearance parts 108 are formed in such a manner as to keep away from the lower-side regions S1 in relation to both the first bonding part 68 and the second bonding part 70. Instead, the clearance parts 108 may be formed in such a manner as to keep away from the lower-side regions S1 in relation to only one of the bonding parts 68 and 70. Also, in the cross-sectional surface shown in FIG. 5A, the holder 32 is of a cross-sectional shape that is located inside the lateral direction X relative to both the first bonding part 68 and the second bonding part 70. Instead, the holder 32 may be of such cross-sectional shape relative to only one of the bonding parts 68 and 70. Also, the posture keeping portion 104 may be placed not only in the lateral direction X of the first upright part 40 of the first terminal 34 but also in the lateral direction of the second upright part 46 of the second terminal 36.

In the third embodiment, the description has been given of an example where their own elastic deformation causes the elastic restoring force to be applied to or exerted on the left electrode contact part 354 of the left conductive member 310 and the right electrode contact part 356 of the right conductive member 312. The generating source of the elastic restoring force may not be the electrode contact parts 354 and 356 of the conductive members 310 and 312. For example, in addition to the conductive members 310 and 312, biasing members such as rubber or springs may be provided integrally with the electrode contact parts 354 and 356 of the conductive members 310 and 312, so that the elastic restoring force caused by the deformation of the biasing members may be applied to the electrode contact parts 354 and 356.

In the third embodiment, the description has been given of an example where both the left electrode contact part 354 and the right electrode contact part 356 are pressed against the external electrodes 58, to be connected, by the elastic restoring force applied to the electrode contact parts 354 and 356 themselves. In addition to this, only one of the left electrode contact part 354 and the right electrode contact part 356 may pressed against the external electrode 58, to be connected, by the elastic restoring force applied to the electrode contact part itself. In this case, either one of the electrode contact parts 354 and 356 to which the elastic restoring force is not applied may not be elastically deformed and may be kept in a fixed state.

In the third embodiment, the description has been given of an example where both the left conductive member 310 and the right conductive member 312 have the terminal contact parts 360 and 362, respectively. In addition to this, only one of the left conductive member 310 and the right conductive member 312 may pressed against the terminals 34 and 36, to be connected, by the elastic restoring force applied to the conductive member itself. In this case, the conductive members 310 and 312 having no terminal contact parts 360 and 362 may be electrically connected to the terminal, to be connected, by the solder H.

In the third embodiment, the description has been given of an example where each of the conductive members 310 and 312 is assembled to the holder 32 by using the assembled structure 380. The assembled structure 380 may be configured by a caulking structure, instead of a structure realized by the combination of the protrusion 382 and the hole portion 384. In the case of the caulking structure, either one of cold riveting and hot riveting may be used. Also, when used is the assembled structure 380 where the protrusion 382 and the hole portion 384 are combined together, the shape of a known retaining ring of an SE type or the like may be used as an inner shape of the hole portion 384.

In the third embodiment, the description has been given of an example where the holder 32 is configured such that assembling direction, relative to the holder 32, of respective of the terminals 34 and 36 and the conductive members 310 and 312 as well as the noise countermeasure component 38 are on the lower sides of the height direction Z. All of these assembling directions may not be on the same direction. For example, the holder 32 may be configured such that a part of the assembling directions among a plurality of components are set on the same direction and remaining assembling directions are set on another direction (e.g., the upper side of the height direction Z).

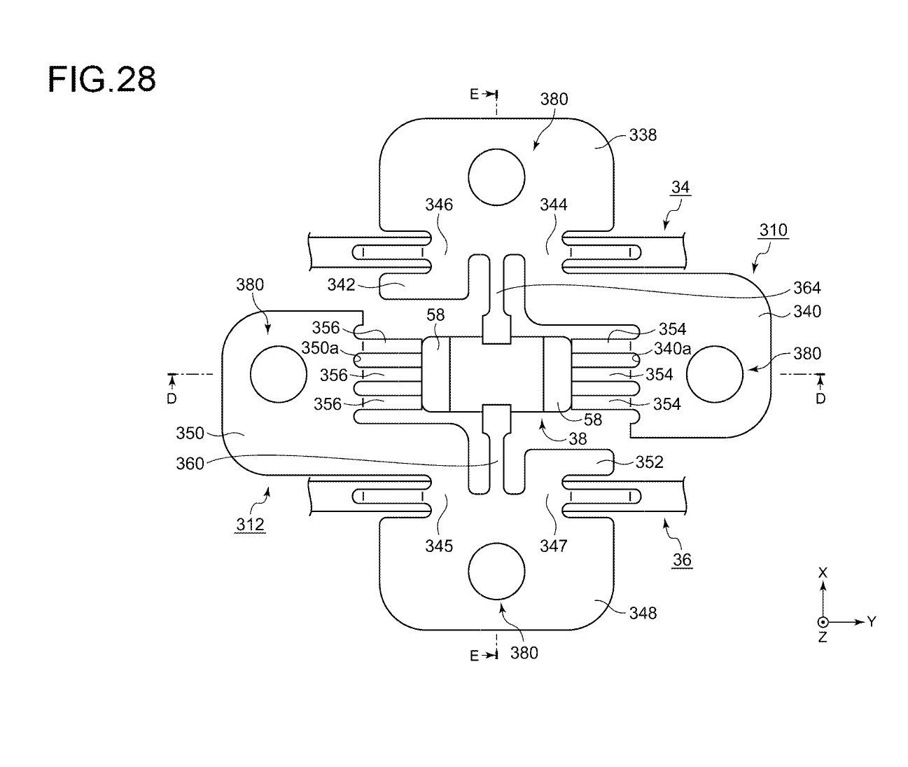

FIG. 28 is a plan view of an enlarged part of a terminal unit 10 according to a fifth modification. This fifth modification of FIG. 28 is shown as a modification of the terminal unit 10 according to the third embodiment. FIG. 28 omits the holder 32.

In the example of FIG. 11, the pair of external electrodes 58 of the noise countermeasure component 38 are provided on the outer surface of both sides of the lateral direction X. In this modification, the pair of external electrodes are provided on the outer surface of both sides of the front-back direction Y.

Also, in the example of FIG. 11, the description has been given of an example where the first electrode contact part 354 (left electrode contact part) of the left conductive member 310 extends from the right-end edge part 338a of the left mounted part 338 and where the second electrode contact part 356 (right electrode contact part) of the right conductive member 312 extends from the left-end edge part 348a of the right mounted part 348. In the example of FIG. 28, the first electrode contact part 354 of the left conductive member 310 extends from the rear-end edge part 340a of the front mounted part 340, whereas the second electrode contact part 356 of the right conductive member 312 extends from the front-end edge part 350a of the rear mounted part 350. A detailed description is given hereunder.

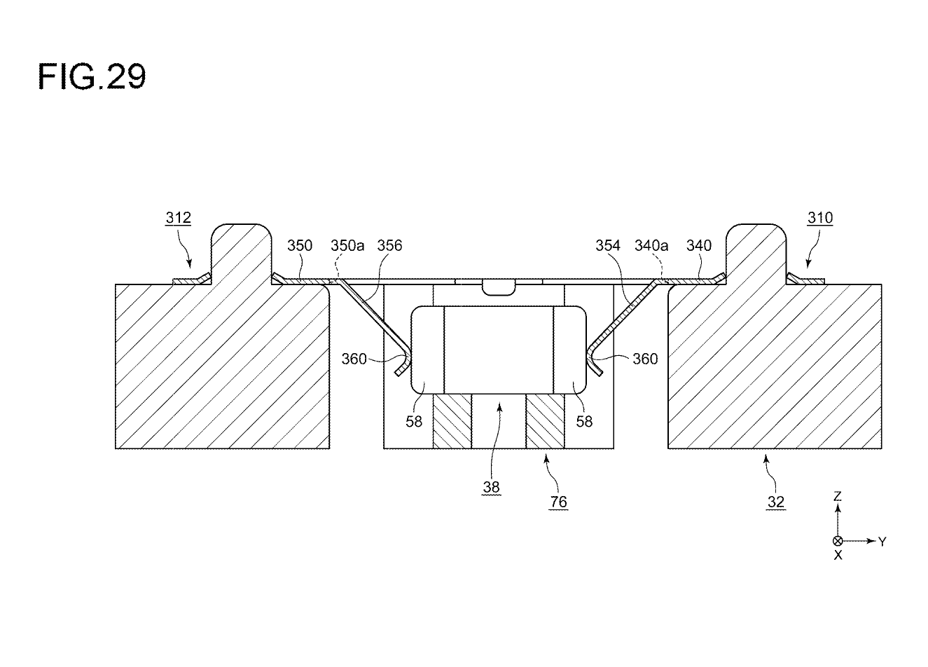

FIG. 29 is a cross-sectional view taken along the line D-D of FIG. 28.

The first electrode contact part 354 of the left conductive member 310 extends toward a lower side, in the height direction Z, from the rear-end edge part 340a of the front mounted part 340. Also, the second electrode contact part 356 of the right conductive member 312 extends toward a lower side, in the height direction Z, from the front-end edge part 350a of the rear mounted part 350. The left electrode contact part 354 and the right electrode contact part 356 are each formed such that the interval, between the inner side surfaces of the left and right electrode contact parts 354 and 356 facing each other in the front-back direction Y, gets narrower toward the lower side of the height direction Z. As a result, the similar operations and advantageous effects to what has been described in the above (B) are realized.

The first electrode contact part 354 and the second electrode contact part 356 are each in an elastically deformed state in the front-back direction Y that enlarges the inner side surfaces of both the first and second electrode contact parts 354 and 356. Thereby, similar to the example of FIG. 11, the left electrode contact part 354 and the right electrode contact part 356 apply the elastic restoring forces, by which the noise countermeasure component 38 is interposed between the both sides thereof in the front-back direction Y, to the noise countermeasure component 38. As a result, the similar operations and advantageous effects to what has been described in the above (A) are realized.

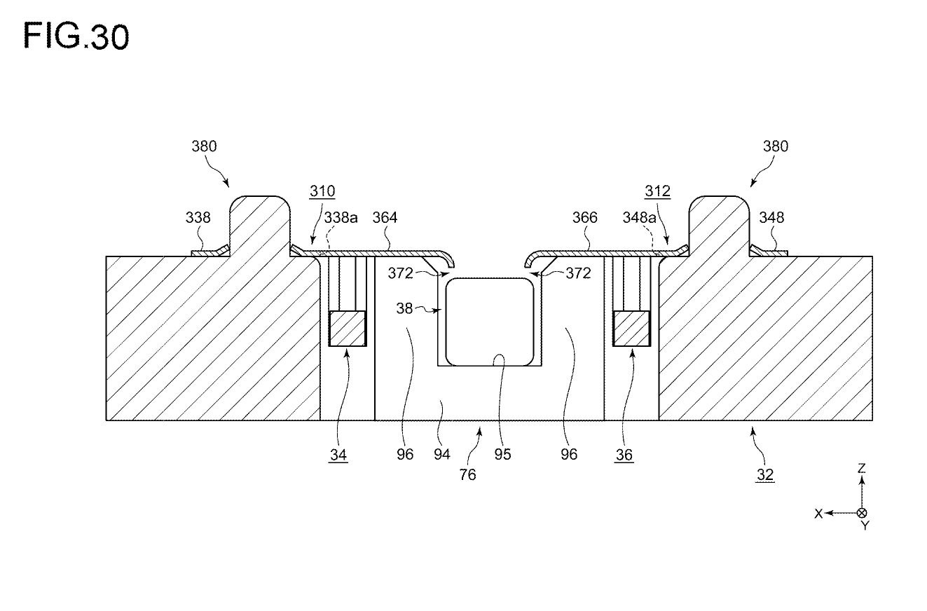

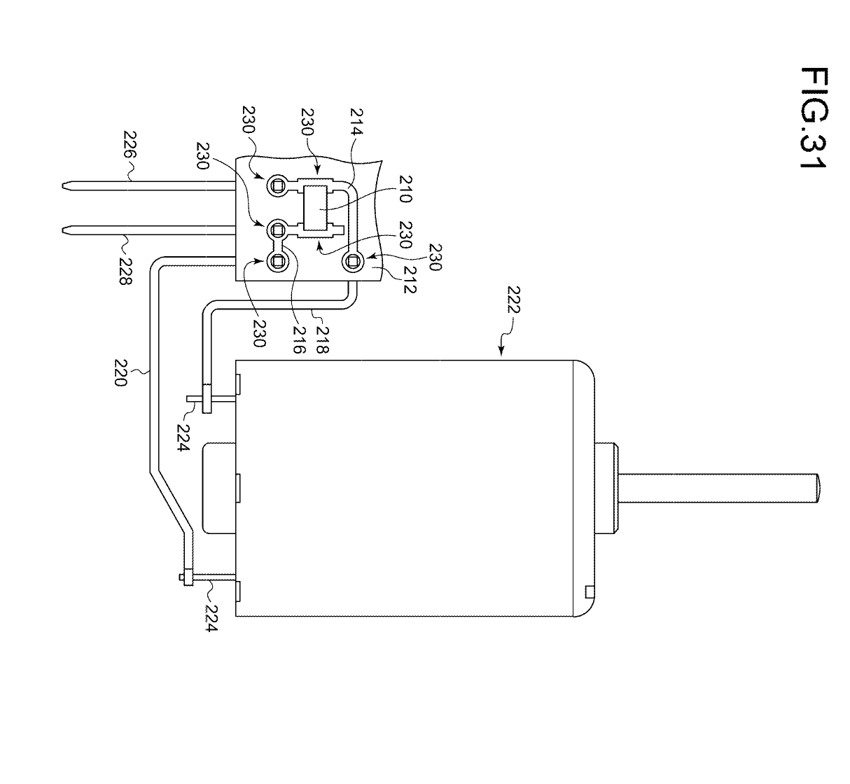

FIG. 30 is a cross-sectional view taken along the line E-E of FIG. 28.

In the example of FIG. 11, the description has been given of an example where the first displacement regulating part 364 (front displacement regulating part) of the left conductive member 310 extends from the rear-end edge part 340a toward the rear side and where the second displacement regulating part 366 (rear displacement regulating part) of the right conductive member 312 extends from the front-end edge part 350a toward the front side. In the example of FIG. 30, the first displacement regulating part 364 of the left conductive member 310 extends from the right-end edge part 338a, whereas the second displacement regulating part 366 of the right conductive member 312 extends from the left-end edge part 348a. In this respect, each of the displacement regulating parts 364 and 366 has the same features as those of the example shown in FIG. 11.

In the example of FIG. 13, the description has been given of an example where the receiving portion 76 of the holder 32 is formed into a groove shape that extends in the lateral direction X. In the example of FIG. 30, the receiving portion 76 thereof is formed into a groove shape that extends in the front-back direction Y. The receiving portion 76 has a bottom wall 94 where a receiving surface 95 is provided, and a pair of side walls 96 that upstand from both right and left ends of the receiving surface 95. When the noise countermeasure component 38 is placed on the receiving portion 76, the receiving portion 76 is engaged with the side walls 96. Thereby, the noise countermeasure component 38 is positioned relative to the receiving portion 76 in the lateral direction X. In this respect, the receiving portion 76 has the same features as those of the example shown in FIG. 13.

It goes without saying that the configuration and arrangement described in each of the modifications may be mutually combined as appropriate. For example, the terminal unit 10 described in each of the first and second embodiments may be contained in the housing 14 in a state where the lateral direction X of the terminal unit 10 is aligned to the axis direction Q of the output shaft 20 of the actuator 12. Also, the terminal unit 10 described in the third embodiment may include the first gripper portion 100 and the second gripper portion 102 described in the first embodiment. Also, the terminal unit 10 described in the third embodiment may include the posture keeping portion 104 described in the first embodiment and the fixing portion 126 described in the second embodiment.

What is claimed is:

1. A terminal unit comprising:
a first terminal having a first connected part;
a second terminal having a second connected part which is arranged in a lateral direction at intervals relative to the first connected part;
a first electronic component where a pair of external electrodes are provided in an outer surface, the first electronic component being arranged between the first connected part and the second connected part; and
a terminal holder that holds the first terminal and the second terminal, the terminal holder having a receiving portion for receiving the first electronic component,
wherein the first electronic component is such that a different external electrode in the pair of external electrodes is electrically connected to the first connected part and the second connected part by way of an electric conductor and wherein a position of the first electronic component relative to the receiving portion is held by the electric conductor.

2. A terminal unit according to claim 1, wherein either one or both of the first connected part and the second connected part is/are connected to the external electrodes, to be connected, by an electrically conductive bonding material that serves as the electric conductor and is/are arranged at intervals relative to the first electronic component.

3. A terminal unit according to claim 1, wherein either one or both of the first connected part and the second connected part is/are connected to the external electrodes, to be connected, by an electrically conductive bonding material that serves as the electric conductor, and
wherein the terminal holder is formed in such a manner as to keep away from a lower-side region in a height direction, which is perpendicular to the lateral direction, in relation to a bonding part of either one or both of the first connected part and the second connected part and the first electronic component.

4. A terminal unit according to claim 1, wherein either one or both of the first connected part and the second connected part is/are connected to the external electrodes, to be connected, by an electrically conductive bonding material that serves as the electric conductor, and
wherein, in a cross-sectional shape that is so cut along a height direction perpendicular to the lateral direction and along the lateral direction as to pass through the first connected part and the second connected part, the terminal holder is of a cross-sectional shape that is located inside the lateral direction relative to a bonding part of either one or both of the first connected part and the second connected part and the first electronic component.

5. A terminal unit according to claim 1, wherein the electric conductor includes:
a first conductive member that electrically connects one of the pair of external electrodes and the first connected part, the first conductive member having a first electrode contact part that is in contact with said one of the pair of external electrodes; and
a second conductive member that electrically connects the other of the pair of external electrodes and the second connected part, the second conductive member having a second electrode contact part that is in contact with said other of the pair of external electrodes,
wherein either one or both of the first electrode contact part and the second electrode contact part is/are pressed against the external electrode, to be connected, by an elastic restoring force applied to thereto.

6. A terminal unit according to claim 5, wherein the first electronic component is configured such that the pair of external electrodes are provided on the outer surface of both sides of one of a front-back direction, which is perpendicular to the lateral direction, and the lateral direction, and
wherein the first electrode contact part and the second electrode contact part apply the elastic restoring force to the first electronic component such that the first electronic component is interposed between the both sides of the one of the front-back direction and the lateral direction.

7. A terminal unit according to claim 5, wherein either one or both of the first conductive member and the second conductive member has/have a terminal contact part that is in contact with the first terminal or the second terminal, to be connected, and
wherein the terminal contact part is pressed against the first terminal or the second terminal by the elastic restoring force applied to oneself.

8. A terminal unit according to claim 5, wherein the first electronic component is configured such that the pair of external electrodes are provided on the outer surface of both sides of one of a front-back direction, which is perpendicular to the lateral direction, and the lateral direction,
wherein the first conductive member is arranged at one side of the one of the front-back direction and the lateral direction, relative to the first electronic component, and has a first mounted part that is mounted on the terminal holder,
wherein the second conductive member is arranged at the other side of the one of the front-back direction and the lateral direction, relative to the first electronic component, and has a second mounted part that is mounted on the terminal holder, and
wherein the first electrode contact part and the second electrode contact part each has a plate-like shape that extends toward a lower side, in a height direction perpendicular to the lateral direction, from an end edge part of the first mounted part and the second mounted part opposite to the one of the front-back direction and the lateral direction, and
the first electrode contact part and the second electrode contact part are each formed such that an interval, between inner side surfaces thereof facing each other in the one of the front-back direction and the lateral direction, gets narrower toward the lower side of the height direction.

9. A terminal unit according to claim 5, wherein either one or both of the first conductive member and the second conductive member has/have a displacement regulating part that is arranged on an opposite side of the receiving portion relative to the first electronic component.

10. A terminal unit according to claim 5, wherein the first conductive member and the second conductive member are constructed by using a common part.

11. A terminal unit according to claim 1, wherein a position of the first electronic component is determined in one of a front-back direction, which is perpendicular to the lateral direction, and the lateral direction.

12. A terminal unit according to claim 1, wherein the terminal holder has a holder body,
wherein the holder body has a first base provided at a front side of the receiving portion, a second base provided at a rear side thereof, and the receiving portion, and
wherein, in the holder body, a gripper portion, which extends along the front-back direction perpendicular to the lateral direction, is formed at an edge portion of one side of the lateral direction.

13. A terminal unit according to claim 1, further comprising a second electronic component used in association with an electric apparatus to which the first terminal and the second terminal electrically connect, and
wherein the terminal holder further includes a fixing portion by which to fix the second electronic component.

14. A motor actuator comprising:
a housing;
an output shaft that is rotated by a motor contained in the housing, the output shaft being provided such that the output shaft is partially exposed to an outside of the housing;
a terminal unit, according to claim 1, which is contained in the housing,
wherein the terminal unit is contained in the housing such that the lateral direction thereof is aligned to an axis direction of the output shaft.

15. A motor actuator according to claim 14, wherein the electric conductor includes:
a first conductive member that electrically connects one of the pair of external electrodes and the first connected part, the first conductive member having a first electrode contact part that is in contact with said one of the pair of external electrodes; and
a second conductive member that electrically connects the other of the pair of external electrodes and the second connected part, the second conductive member having a second electrode contact part that is in contact with said other of the pair of external electrodes,
wherein either one or both of the first electrode contact part and the second electrode contact part is/are pressed against the external electrode, to be connected, by an elastic restoring force applied to thereto.

16. A terminal holder comprising:
a first holding portion that holds a first terminal having a first connected part;
a second holding portion that holds a second terminal having a second connected part, which is arranged in a lateral direction at intervals relative to the first connected part; and
a receiving portion that receives a first electronic component arranged between the first connected part and the second connected part.
